(19) United States
(12) Patent Application Publication
(10) Pub. No.: US 2006/0235210 A1
(43) Pub. Date: Oct. 19, 2006

(54) Azo metal dyes and optical data carrier containing one such azo metal dye as a light absorbing compound in the information layer

(76) Inventors: Horst Berneth, Leverksen (DE); Friedrich Karl Bruder, Krefeld (DE); Rainer Hagen, Leverkusen (DE); Karin Hassenruck, Dusseldorf (DE); Serguei Kostromine, Swisttal (DE); Christa Maria Kruger, Schneverdingen (DE); Rafael Oser, Krefeld (DE); Josef-Walter Stawitz, Odenthal (DE); Monika Engel, Keverkusen (DE); Timo Meyer-Friedrichsen, Krefeld (DE)

Correspondence Address: Lanxess Corporation;Law & Intellectual Property Department, 111 Ride Park West Drive, Pittsburgh, PA, 15275-1112, US

(21) Appl. No.: 10/544,447

(22) PCT Filed: Jan. 31, 2004
(86) PCT No.: PCT/EP04/00882

§ 371 Date: May 3, 2006

(30) Foreign Application Priority Data
Feb. 13, 2003 (DE) 103 05 925.3

(51) Int. Cl. C09B 56/00

(52) U.S. Cl. 534/653

(57) ABSTRACT

Optical data carrier comprising a preferably transparent substrate which may, if desired, have previously been coated with one or more reflection layers and to whose surface a light-writeable information layer, if desired one or more reflection layers and if desired a protective layer or a further substrate or a covering layer have been applied, which can be written on and read by means of blue, red or infrared light, preferably laser light, where the information layer comprises a light-absorbent compound and, if desired, a binder, characterized in that at least one azo metal dye is used as light-absorbent compound.

The invention relates to a write-once optical data carrier comprising an azo metal dye as light-absorbent compound in the information layer, to a process for its production and also to the application of the abovementioned dyes to a polymer substrate, in particular polycarbonate, by spin coating or vapour deposition.

Write-once optical data carriers using specific light-absorbent substances or mixtures thereof are particularly suitable for use in high-density writeable optical data stores which operate with blue laser diodes, in particular GaN or SHG laser diodes (360-460 nm) and/or for use in DVD-R or CD-R disks which operate with red (635-660 nm) or infrared (780-830 nm) laser diodes.

The write-once compact disk (CD-R, 780 nm) has recently experienced enormous volume growth and represents the technically established system.

The next generation of optical data stores—DVDs—is currently being introduced onto the market. Through the use of shorter-wave laser radiation (635-660 nm) and higher numerical aperture NA, the storage density can be increased. The writeable format in this case is DVD-R (DVD-R, DVD+R).

Today, optical data storage formats which use blue laser diodes (based on GaN, JP 08 191 171 or Second Harmonic Generation SHG JP 09 050 629) (360 nm-460 nm) with high laser power are being developed. Writeable optical data stores will therefore also be used in this generation. The achievable storage density depends on the focussing of the laser spot on the information plane. Spot size scales with the laser wavelength λ/NA. NA is the numerical aperture of the objective lens used. In order to obtain the highest possible storage density, the use of the smallest possible wavelength A is the aim. At present 390 nm is possible on the basis of semiconductor laser diodes.

The patent literature describes dye-based writeable optical data stores which are equally suitable for CD-R and DVD-R (DVD-R, DVD+R) systems (JP-A 11 043 481 and JP-A 10 181 206). To achieve a high reflectivity and a high modulation height of the read-out signal and also to achieve sufficient sensitivity in writing, use is made of the fact that the IR wavelength of 780 nm of CD-Rs is located at the foot of the long wavelength flank of the absorption peak of the dye and the red wavelength of 635 nm or 650 nm of DVD-Rs (DVD-R, DVD+R) is located at the foot of the short wavelength flank of the absorption peak of the dye. In JP-A 02 557 335, JP-A 10058 828, JP-A 06 336086, JP-A 02 865 955, WO-A 09 917 284 and U.S. Pat. No. 5,266,699, this concept is extended to the 450 nm working wavelength region on the short wavelength flank and the red and IR region on the long wavelength flank of the absorption peak.

Apart from the abovementioned optical properties, the writeable information layer comprising light-absorbent organic substances has to have a substantially amorphous morphology to keep the noise signal during writing or reading as small as possible. For this reason, it is particularly preferred that crystallization of the light-absorbent substances be prevented in the application of the substances by spin coating from a solution, by vapour deposition and/or sublimation during subsequent covering with metallic or dielectric layers under reduced pressure.

The amorphous layer comprising light-absorbent substances should preferably have a high heat distortion resistance, since otherwise further layers of organic or inorganic material which are applied to the light-absorbent information layer by sputtering or vapour deposition would form blurred boundaries due to diffusion and thus adversely affect the reflectivity. Furthermore, a light-absorbent substance which has insufficient heat distortion resistance can, at the boundary to a polymeric support, diffuse into the latter and once again adversely affect the reflectivity.

A light-absorbent substance whose vapour pressure is too high can sublime during the abovementioned deposition of further layers by sputtering or vapour deposition in a high vacuum and thus reduce the layer thickness to below the desired value. This in turn has an adverse effect on the reflectivity.

It is therefore an object of the invention to provide suitable compounds which satisfy the high requirements (e.g. light stability, favourable signal/noise ratio, damage-free application to the substrate material, and the like) for use in the information layer in a write-once optical data carrier, in particular for high-density writeable optical data store formats in a laser wavelength range from 340 to 830 nm.

Surprisingly, it has been found that light-absorbent compounds selected from the group of azo metal dyes can satisfy the abovementioned requirement profile particularly well.

The invention accordingly provides an optical data carrier comprising a preferably transparent substrate which may, if desired, have previously been coated with one or more reflection layers and to whose surface a light-writeable information layer, if desired one or more reflection layers and if desired a protective layer or a further substrate or a covering layer have been applied, which can be written on or read by means of blue, red or infrared light, preferably laser light, where the information layer comprises a light-absorbent compound and, if desired, a binder, characterized in that at least one azo metal dye is used as light-absorbent compound.

The light-absorbent compound should preferably be able to be changed thermally. The thermal change preferably occurs at a temperature of <600° C., particularly preferably at a temperature of <400° C., very particularly preferably at a temperature of <300° C., in particular <200° C. Such a change can be, for example, a decomposition or chemical change of the chromophoric centre of the light-absorbent compound.

The invention therefore provides metal complexes which have at least one ligand of the formula (I) 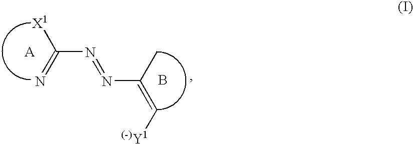
where
X¹ is O, S, N—R¹ or CH,
A together with X¹ and N forms a five- or six-membered aromatic or pseudoaromatic heterocyclic ring which contains from 1 to 4 heteroatoms and/or may be benzo- or naphtho-fused and/or substituted by nonionic radicals,
Y¹ is O, S, N—R², COO, SO₃, N—CO—R³ or N—SO₂—R³,
B is a five- or six-membered carbocyclic or heterocyclic ring which may contain from 1 to 4 heteroatoms and/or may be benzo- or naphtho-fused and/or substituted by nonionic radicals,
R¹ and R² are each, independently of one another, hydrogen, C¹-C₆-alkyl,
C₆-C₁₀-aryl or C₇-C₁₂-aralkyl,
R³ is C₁-C₁₂-alkyl, C₃-C₇-cycloalkyl, C₂-C₆-alkenyl, C₇-C₁₂-aralkyl, C₆-C₁₀-aryl, C₁-C₆-alkoxy or mono-C₁-C₆-alkylamino or bis-C₁-C₆-alkylamino.

In a preferred embodiment, the metal complexes are in the form of 1:1 or 1:2 metal:azo complexes.

The metals are present in the oxidation state +3 or +4, preferably in the oxidation state +3.

Metal complexes containing two identical or different ligands of the formula (I) are preferred.

Preference is given to metal complexes which have the formula (Ia)
[(I)]₂⁻M³⁺ An− (Ia)
where the two ligands of the formula (I) are each, independently of one another, as defined above,

M is a metal and

An⁻ is an anion.

Preference is likewise given to metal complexes which have the formula (Ib)
[(I)]₂⁻M²⁺−Z (Ib)
where the two ligands of the formula (I) are, independently of one another, as defined above,

M is a metal,

Z is halogen, CN, R⁴—O—, R⁴—S—, R⁴—SO₂—, R⁴—CO—O—, R⁴—SO₂—O—, R⁴—CO—NH— or R⁴—SO₂—NH— and

R⁴ is C₁-C₆-alkyl-C₃-C₇-cycloalkyl or C₇- C₁₂-aralkyl or C₆-C₁₀-aryl.

Preference is likewise given to random mixtures of metal complexes containing two different ligands of the formula (I).

Preferred metals are trivalent metals, transition metals or rare earths, in particular B, Al, Ga, In, V, Co, Cr, Fe, Y, La, Ce, Pr, Nd, Sm, Eu, Gd, Th. Preference is given to B, Al, Co. Particular preference is given to Co.

Nonionic radicals are, for example, halogen, alkyl, alkenyl, aralkyl, aryl, alkoxy, alkylthio, hydroxyl, amino, alkylamino, dialkylamino, cyano, nitro, alkoxycarbonyl, alkylaminocarbonyl or dialkylaminocarbonyl, alkanoyl, aroyl, alkylsulphonyl, arylsulphonyl.

Possible substituents on the alkyl, alkoxy, alkylthio, cycloalkyl, aralkyl, aryl or heterocyclic radicals are halogen, in particular Cl or F, nitro, cyano, hydroxyl, CO—NH₂, CO—O-alkyl or alkoxy. The alkyl radicals can be linear or branched and can be partially halogenated or perhalogenated. Examples of substituted alkyl radicals are trifluoromethyl, chloroethyl, cyanoethyl, methoxyethyl. Examples of branched alkyl radicals are isopropyl, tert-butyl, 2-butyl, neopentyl.

Preferred substituted or unsubstituted C₁-C₁₂-alkyl radicals are methyl, ethyl, n-propyl, isopropyl, n-butyl, 2-butyl, isobutyl, tert-butyl, n-pentyl, n-hexyl, octyl, decyl, dodecyl, perfluorinated methyl, perfluorinated ethyl, 3,3,3-trifluoroethyl, 2,2,3,3-tetrafluoropropyl, perfluorobutyl, cyanoethyl, methoxyethyl.

Examples of preferred aralkyl radicals are benzyl, phenethyl and phenylpropyl.

The metal complexes of the formula (Ia) are presumably in the form represented by the formula (IIa) 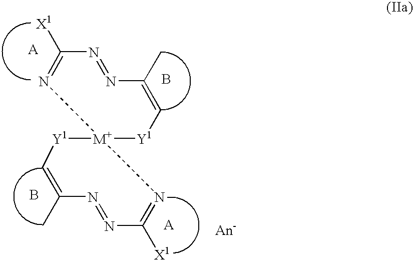
and the metal complexes of the formula (Ib) are presumably in the form represented by the formula (IIb) 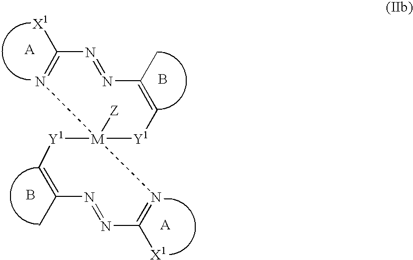
where M, An⁻, Z and the radicals of the respective azo ligands are, independently of one another, as defined above. For the purposes of the- present patent application, it is assumed that the formulae (IIa) and (Ia) and the formulae (IIb) and (Ib) in each case characterize the same compounds.

Particular preference is given to an azo metal dye of the formula (I), (Ia), (Ib), (IIa) or (IIb),
where the ring A of the formula 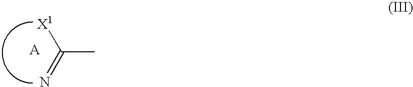
is benzothiazol-2-yl, benzoxazol-2-yl, benzinidazol-2-yl, thiazol-2-yl, thiazol-4-yl, imidazol-2-yl, pyrazol-5-yl, 1,3,4-thiadiazol-2-yl, 1,2,4-thiadiazol-5-yl, 1,2,4-thiadiazol-3-yl, 1,3,4-oxadiazol-2-yl, 1,3,4-triazol-2-yl, 2-pyridyl, 2-quinolyl, 3-pyridazinyl, 2-pyrimidyl, 1,3,5-triazin-2-yl or 2-pyrazinyl, each of which may be substituted by C₁-C₆-alkyl, C₁-C₆-alkoxy, fluorine, chlorine, bromine, iodine, cyano, —C(═NH)—O—C₁-C₆-alkyl, nitro, C₁-C₆-alkoxycarbonyl, C₁-C₆-alkylthio, C₁-C₆-acylamino, formyl, C₂-C₆-alkanoyl, C₆-C₁₀-aryl, C₆-C₁₀-aryloxy, C₆-C₁₀-arylcarbonylamino, mono-C₁-C₆-alkylamino or di-C₁-C₆-alkylamino, N—C₁-C₆-alkyl-N—C₆-C₁₀-arylamino, pyrrolidino, morpholino, piperazino or piperidino,
where
X¹ is O, S, N—R¹ or CH,
the ring B of the formula 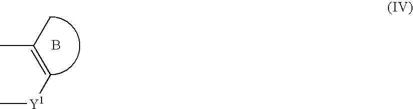
is a radical of one of the formulae 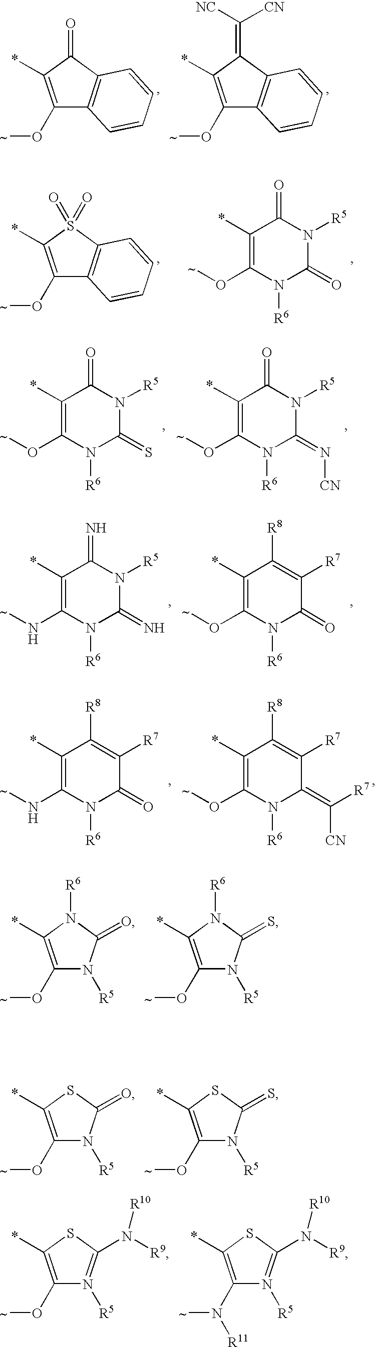 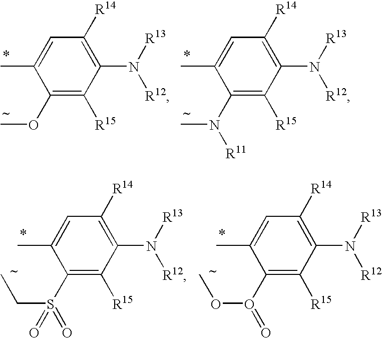
R¹ is hydrogen, methyl, ethyl, propyl, butyl, benzyl or phenethyl,
R⁵ and R⁶ are each, independently of one another, hydrogen, methyl, ethyl, propyl, butyl, benzyl, phenethyl, cyclopentyl, cyclohexyl, phenyl, tolyl, methoxyphenyl or chlorophenyl,
R⁷ is cyano, methoxycarbonyl, ethoxycarbonyl or a radical of the formula 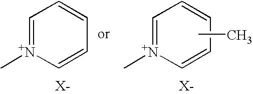
R⁸ is hydrogen, methyl, ethyl, trifluoromethyl, cyano, methoxycarbonyl or ethoxycarbonyl,
R⁹, R¹⁰, R¹² and R¹³ are each, independently of one another, hydrogen, methyl, ethyl, propyl, butyl, cyanoethyl, hydroxyethyl, methoxyethyl, chloroethyl, benzyl, phenethyl, cyclopentyl, cyclohexyl, phenyl, tolyl, methoxyphenyl or chlorophenyl or
NR⁹R¹⁰ and NR¹²R¹³ can each be, independently of one another, pyrrolidino, piperidino, piperazino or morpholino,
R¹⁴ and R¹⁵ are each, independently of one another, hydrogen, methyl, ethyl, methoxy or chlorine or
R¹²; R¹⁵ and R¹³; R¹⁴ may in each case form, independently of one another, a —(CH₂)₂—, —(CH₂)₃— or —(CH₂)₂—O— bridge which may be substituted by up to three methyl groups,
R¹¹ is hydrogen, methyl, ethyl, 2,2,3,3-tetrafluoropropyl, formyl, acetyl, trifluoroacetyl, propionyl, butanoyl, benzoyl, pyridoyl, methanesulphonyl, trifluoromethanesulphonyl, ethanesulphonyl, 2,2-difluoroethanesulphonyl, 2,2,2-trifluoroethanesulphonyl, perfluorobutanesulphonyl, benzenesulphonyl, chlorobenzenesulphonyl or toluenesulphonyl,
An⁻ is an anion,
Z is fluorine, chlorine, bromine, CN, acetate, benzoate, methoxy, methylthio or benzenesulphinate,
M is B, Al, Ga, Co, Cr, Fe, Y, La or Ce,
the asterisked (*) bond leads to the azo group and
the bond denoted by “˜” leads to the metal M.

Particular preference is given to Z being fluorine.

Very particular preference is given to metal complexes of the formulae (I), (Ia), (Ib), (IIa) or (IIb),

in which

the ring A of the formula (III) 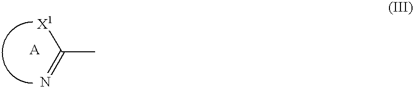
is benzothiazol-2-yl which may bear up to three identical or different radicals selected from the group consisting of chlorine, methyl, methoxy, ethoxy, cyano and nitro as substituents, benzimidazol-2-yl which may bear up to three identical or different radicals selected from the group consisting of chlorine, methyl, methoxy, ethoxy, cyano and nitro as substitutents, thiazol-2-yl which may bear up to two identical or different radicals selected from the group consisting of chlorine, fluorine, methyl, trifluoromethyl, methoxy, phenyl, cyano, nitro, methoxycarbonyl, methanesulphonyl, formyl and the bivalent radical of the formula —(CH₂)₄— as substituents, thiazol4-yl which may bear up to two identical or different radicals selected from the group consisting of chlorine, fluorine, methoxy, methylthio, phenyl and cyano as substituents, imidazol-2-yl which may bear up to two identical or different radials selected from the group consisting of fluorine, chlorine, methyl, trifluoromethyl, methoxy, phenyl, cyano, nitro, CH₃O—(C═NH)—, methoxycarbonyl and ethoxycarbonyl as substituents, pyrazol-5-yl which may bear up to two identical or different radicals selected from the group consisting of chlorine, methyl, methoxy, phenyl, cyano and nitro as substituents, 1,3,4-thiadiazol-2-yl which may bear chlorine, bromine, methoxy, phenoxy, methanesulphonyl, methylthio, ethylthio, dimethylamino, diethylamino, diisopropylamino, N-methyl-N-cyanoethylamino, N,N-biscyanoethylamino, N-methyl-N-hydroxyethylamino, N-methyl-N-benzylamino, N-methyl-N-phenylamino, anilino, pyrrolidino, piperidino or morpholino substituents, 1,2,4-thiadiazol-5-yl which may bear chlorine, methyl, methoxy, phenoxy, methylthio, methanesulphonyl, phenyl, dimethylamino or anilino substituents, 1,2,4-thiadiazol-3-yl which may bear methyl or phenyl substituents, 1,3,4-triazol-2-yl which may bear methyl or phenyl substituents, 2-pyridyl which may bear chlorine, methyl,, methoxy, cyano, methoxycarbonyl or nitro substituents, 2-quinolyl which may bear chlorine, methyl, methoxy, cyano, methoxycarbonyl or nitro substituents, 2-pyrimidyl which may bear up to three identical or different radicals selected from the group consisting of chlorine, methyl, methoxy, cyano, methoxycarbonyl and nitro as substituents, 1,3,5-triazin-2-yl or 2-pyrazinyl,
   where
X¹ is O, S, N—R¹ or CH.

Possible anions An- are all monovalent anions or one equivalent of a polyvalent anion or one equivalent of an oligomeric or polymeric anion. Preference is given to colourless anions. Examples of suitable anions are chloride, bromide, iodide, nitrate, tetrafluoroborate, perchlorate, hexafluorosilicate, hexafluorophosphate, methosulphate, ethosulphate, C₁-C₁₀-alkanesulphonate, C₁-C₁₀-perfluoroalkane-sulphonate, unsubstituted or chloro-, hydroxy- or C₁-C₄-alkoxy-substituted C₁-C₁₀-alkanoate, unsubstituted or nitro-, cyano-, hydroxy-, C₁-C₂₅-alkyl-, perfluoro-C₁-C₄-alkyl-, C₁-C₄-alkoxycarbonyl- or chloro-substituted benzenesulphonate or naphthalenesulphonate or biphenylsulphonate, unsubstituted or nitro-, cyano-, hydroxy-, C₁-C₄-alkyl-, C₁-C₄-alkoxy-, C₁-C₄-alkoxycarbonyl- or chloro-substituted benzenedisulphonate or naphthalenedisulphonate or biphenyldisulphonate, unsubstituted or nitro-, cyano-, C₁-C₄-alkyl-, C₁-C₄-alkoxy-, C₁-C₄-alkoxycarbonyl-, benzoyl-, chlorobenzoyl- or toluoyl-substituted benzoate, the anion of naphthalenedicarboxylic acid, (diphenyl ether) disulphonate, tetraphenylborate, cyanotriphenylborate, tetra-C₁-C₂₀-alkoxyborate, tetraphenoxyborate, 7,8- or 7,9-dicarbanidoundecaborate(1) or (2) which may each be substituted on the B and/or C atoms by one or two C₁-C₁₂-alkyl or phenyl groups, dodecahydrodicarba-dodecaborate(2) or B-C₁-C₁₂-alkyl-C-phenyldodecahydrodicarbadodecaborate(1), polystyrenesulphonate, poly(meth)acrylate, polyallylsulphonate.

Preference is given to bromide, iodide, tetrafluoroborate, perchlorate, hexafluoro-phosphate, methanesulphonate, trifluoromethanesulphonate, benzenesulphonate, toluenesulphonate, dodecylbenzenesulphonate, tetradecanesulphonate, polystyrene-sulphonate.

Furthermore, it is possible to use all monovalent anions or one equivalent of a polyvalent anion of a dye as anions An⁻. The anionic dye An preferably has an absorption spectrum similar to that of the cationic azo metal salt. Suitable examples are anionic azo dyes, anthrequinone dyes, porphyrins, phthalocyanines, sub-phthalocyanines, cyanines, merocyanes, rhodanes, metal complexes and oxonols.

Suitable rhodamine dyes include those of the formula (C) 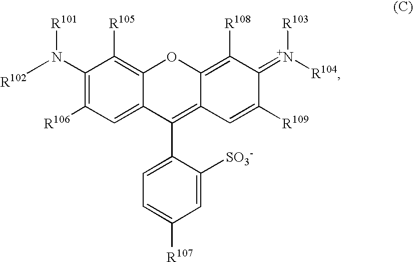
where
R¹⁰¹ and R¹⁰³ are each, independently of one another, hydrogen, methyl or ethyl,
R¹⁰² and R¹⁰⁴ are each, independently of one another, a sulpho- or carboxy-substituted phenyl, naphthyl, benzothiazolyl or benzoxazolyl radical which may be substituted by chlorine, hydroxyl, methyl, methoxy or methylthio,
R¹⁰⁵, R¹⁰⁶, R¹⁰⁸ and R¹⁰⁹ are each, independently of one another, hydrogen, methyl or methoxy or
R¹⁰¹, R¹⁰⁵, R¹⁰²; R¹⁰⁶, R¹⁰³; R¹⁰⁸ and R¹⁰⁴; R¹⁰⁹ each represent, independently of one another, —(CH₂)₂—, —(CH₂)₃—, —C(CH₃)₂—CH₂—CH(CH₃)— or —O(CH₂)₂—, and
R¹⁰⁷ is hydrogen or sulpho.

Suitable oxonol dyes include those of the formula (CI) 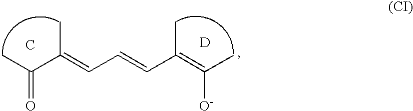
where

the rings C and D are each a five- or six-membered, carbocyclic or heterocyclic ring.

In the formula (CI), C and D are preferably identical.

Preference is given to the ring C together with the two carbon atoms and the oxygen atom being a radical of one of the formulae 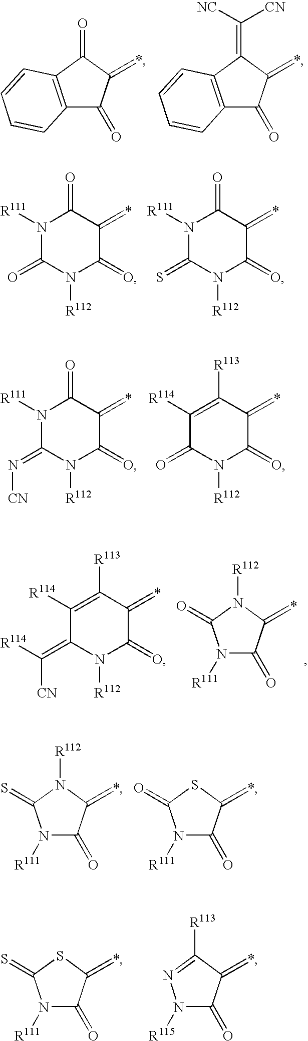
and the ring D together with the two carbon atoms and the oxygen atom being a radical of one of the formulae 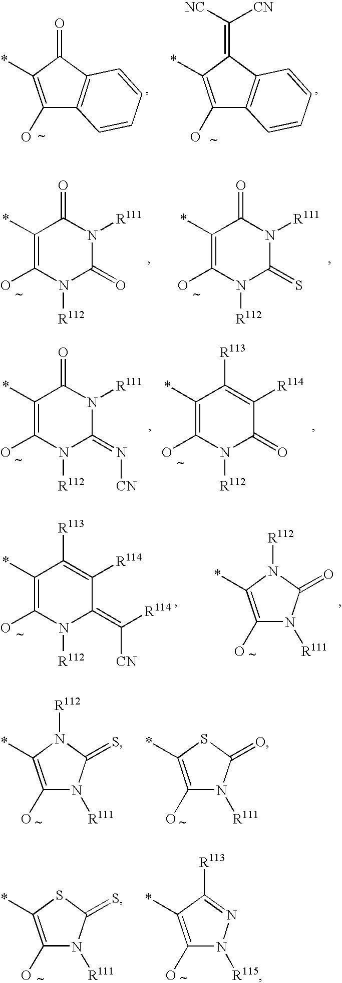
where

R¹¹¹ and R¹¹² are each, independently of one another, hydrogen or methyl,

R¹¹³ is methyl or trifluoromethyl,

R¹¹⁴ is cyano, methoxycarbonyl or ethoxycarbonyl,

R¹¹⁵ is phenyl, chlorophenyl or tolyl.

Suitable azo metal complex dyes include those of the formula (CII) 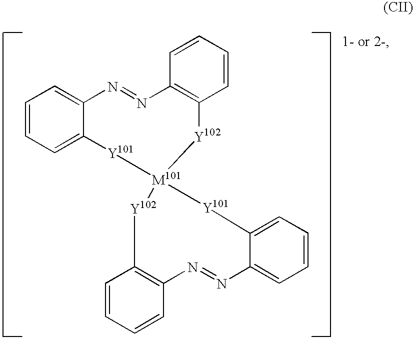
where

Y¹⁰¹ and Y¹⁰² are each, independently of one another, —O— or —COO—,

M¹⁰¹ is a divalent or trivalent metal and

the benzene rings may be benzo-fused and/or be substituted by nonionic radicals.

Nonionic radicals are defined above.

M¹⁰¹ is preferably Ni, Co, Cr. Fe, Cu.

In a very particularly preferred embodiment, the azo metal dyes used are dyes of the formula (I), (Ia), (Ib), (IIa) or (IIb),

in which

the ring A of the formula (III) 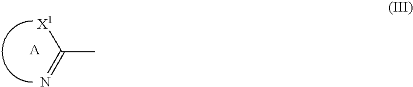
is benzothiazol-2-yl, chlorobenzothiazol-2-yl, methylbenzothiazol-2-yl, methoxybenzothiazol-2-yl or nitrobenzothiazol-2-yl, benzimidazol-2-yl, thiazol-2-yl, phenylthiazol-2-yl, cyanothiazol-2-yl, nitrothiazol-2-yl, 5-fluoro-4-trifluoromethylthiazol-2-yl, 5-phenyltrifluoromethyl-thiazol-2-yl, 2-methylthio-5-cyanothiazol4yl, imidazol-2-yl, 4,5-diphenylimidazol-2-yl, 4,5-dicyanoimidazol-2-yl, 4,5-bismethoxy-carbonylimidazol-2-yl or 4,5-bisethoxycarbonylimidazol-2-yl, pyrazol-5-yl, 1,3,4-thiadiazol-2-yl, 5-phenoxy-1,3,4-thiadiazol-2-yl, 5-methylthio-1,3,4-thiadiazol-2-yl, 5-dimethylamino-1,3,4-thiadiazol-2-yl, 5-diethylamino-1,3,4-thiadiazol-2-yl, 5-di(iso)propylamino-1,3,4-thiadiazol-2-yl, 5-N-methyl-N-cyanoethylamino-1,3,4-thiadiazol-2-yl, 5-pyrrolidino-1,3,4-thiadiazol-2-yl, 5-phenyl-1,3,4-thiadiazol-2-yl, 5-methyl-1,3,4-thiadiazole, 1,2,4-thiadiazol-5-yl, 3-methylthio-1,2,4-thiadiazol-5-yl, 3-methanesulphonyl-1,2,4-thiadiazol-5-yl, 3-phenyl-1,2,4-thiadiazol-5-yl, 5-methyl-1,2,4-thiadiazol-3-yl, 1,3,4triazol-2-yl, 2-pyridyl, 2-quinolyl, 2-pyrimidyl, 4-cyano-2-pyrimidyl, 4,6-dicyano-2-pyrimidyl, 1,3,5-triazin-2-yl or 2-pyrazinyl,
   where
X¹ is O, S, N—R¹ or CH,

R¹ is hydrogen, methyl, ethyl or benzyl,
the ring B of the formula (I) 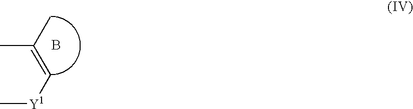
is a radical of one of the formulae 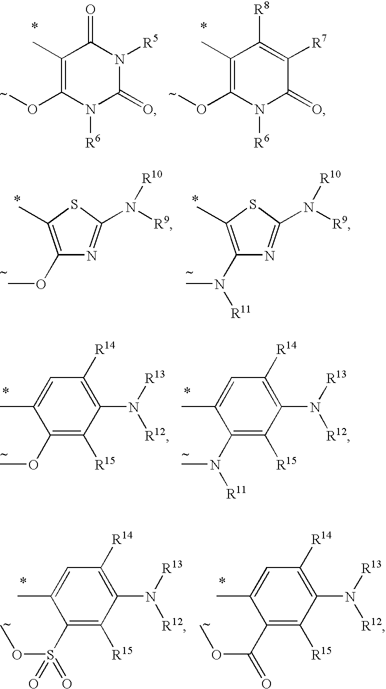
R⁵ and R⁶ are each, independently of one another, hydrogen, methyl or ethyl,
R⁷ is cyano or methoxycarbonyl,
R⁸ is hydrogen, methyl, trifluoromethyl or cyano,
R⁹, R¹⁰, R¹² and R¹³ are each, independently of one another, hydrogen, methyl, ethyl, propyl, butyl, cyanoethyl, methoxyethyl, chloroethyl, benzyl, cyclohexyl, phenyl, tolyl or methoxyphenyl or
NR⁹R¹⁰ and NR¹²R¹³ are each, independently of one another, pyrrolidino, piperidino or morpholino,
R¹⁴ and R¹⁵ are each, independently of one another, hydrogen, methyl or methoxy or
R¹²; R¹⁵ and R¹³; R¹⁴ may in each case form, independently of one another, a —(CH₂)₂— or —(CH₂)₃— bridge,
R¹¹ is 2,2,3,3-tetrafluoropropyl, acetyl, propionyl, benzoyl, pyridoyl, methanesulphonyl, trifluoromethanesulphonyl, ethanesulphonyl, perfluorobutanesulphonyl or benzenesulphonyl,
An⁻ is tetrafluoroborate, perchlorate, hexafluorophosphate, nitrate, methoxyacetate, methanesulphonate, ethanesulphonate, trifluoromethanesulphonate, benzenesulphonate, toluenesulphonate, butylbenzenesulphonate, chlorobenzenesulphonate, dodecylbenzenesulphonate, naphthalenesulphonate, an equivalent of polystyrenesulphonate or the anion of the formula 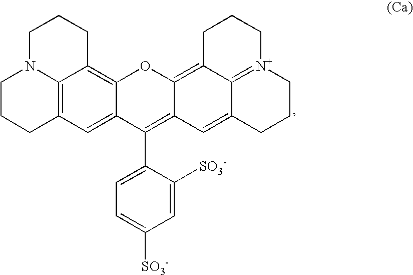
Z is fluorine,
M is B, Al or Co,
the asterisked (*) bond leads to the azo group and
the bond denoted by “˜” leads to the metal M.

In an especially preferred embodiment, the azo metal dyes used are dyes of the formula (I), (Ia) or (IIa),

in which

the ring A of the formula (II) 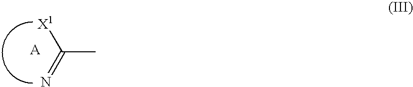
is 4,5-dicyanoimidazol-2-yl, 1-methyl-4,5-dicyanoimnidazol-2-yl, 1-ethyl4,5-dicyanoimidazol-2-yl, 1-benzyl-4,5-dicyanoimidazol-2-yl, 1-(2,2,2-trifluoroethyl)4,5-dicyanoimidazol-2-yl, 3-phenyl-1,2,4-thiadiazolyl, 3-methanesulphonyl-1,2,4-thiadiazolyl, 5-dimethylamino-1,3,4-thiadiazolyl, 5-diisopropylamino-1,3,4-thiadiazolyl, 5-pyrrolidino-1,3,4-thiadiazolyl, 5-phenyl-1,3,4-thiadiazol-2-yl, 5-methyl-1,3,4-thiadiazolyl, 2-pyridyl, 2-pyrimidyl, 4-cyano-2-pyrimidyl,

the ring B of the formula (IV) 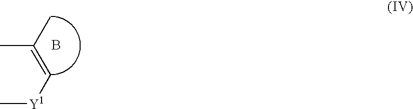
is a radical of the formula 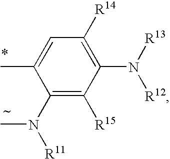
R¹² and R¹³ are each, independently of one another, hydrogen, methyl, ethyl, propyl, cyanoethyl, benzyl, cyclohexyl or phenyl or
NR¹²R¹³ is pyrrolidino, piperidino or morpholino,
R¹⁴ and R¹⁵ are each hydrogen or
R¹²; R¹⁵ and R¹³; R¹⁴ may in each case form, independently of one another, a —(CH₂)₂— or —(CH₂)₃— bridge,
R¹¹ is methanesulphonyl, trifluoromethanesulphonyl or perfluorobutanesulphonyl,
An⁻ is tetrafluoroborate, perchlorate, hexafluorophosphate, nitrate, trifluoromethanesulphonate or the anion of the formula 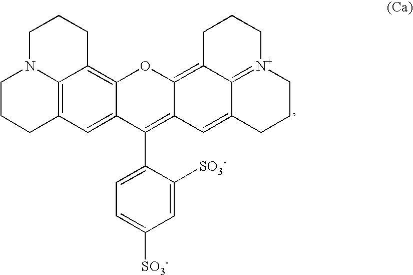
M is Co,
the asterisked (*) bond leads to the azo group and
the bond denoted by “˜” leads to the metal M.

The metal complexes of the invention are marketed, in particular, as powder or granulated material or as a solution having a solids content of at least 2% by weight. Preference is given to the granulated form, in particular granulated materials having a mean particle size of from 50 μm to 10 mm, in particular from 100 to 800 μm. Such granulated materials can be produced, for example, by spray drying. The granulated materials are, in particular, low in dust.

The metal complexes of the invention have a good solubility. They are readily soluble in nonfluorinated alcohols. Such alcohols are, for example, those having from 3 to 6 carbon atoms, preferably propanol, butanol, pentanol, hexanol, diacetone alcohol or mixtures of these alcohols, e.g. propane/diacetone alcohol, butanol/diacetone alcohol, butanol/hexanol. Preferred mixing ratios for the mixtures mentioned are, for example, from 80:20 to 99:1, preferably from 90:10 to 98:2.

Preference is likewise given to the concentrated solutions. They have a concentration of at least 1% by weight, preferably at least 2% by weight, particularly preferably at least 5% by weight, of the metal complexes of the invention, in particular those of the formulae (Ia), (Ib), (IIa) and (IIb). As solvents, preference is given to using 2,2,3,3-tetrafluoropropanol, propanol, butanol, pentanol, hexanol, diacetone alcohol, dibutyl ether, heptanone or mixtures thereof. Particular preference is given to 2,2,3,3-tetrafluoropropanol. Butanol is likewise particularly preferred Particular preference is likewise given to butanol/diacetone alcohol in a mixing ratio of from 90:10 to 98:2.

The invention further provides a process for preparing the novel metal complexes of the formulae (Ia) and (Ib), which is characterized in that a metal salt is reacted with an azo compound of the formula (Ic) 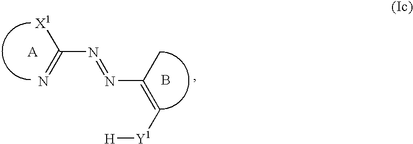
where
X¹ is O, S, N—R¹ or CH,
A together with X¹ and N forms a five- or six-membered aromatic or pseudoaromatic heterocyclic ring which contains from 1 to 4 heteroatoms and/or may be benzo- or naphtho-fused and/or substituted by nonionic radicals,
Y¹ is O, S, N—R², COO, SO₃, N—CO—R³ or N—SO₂—R³,
B is a five- or six-membered carbocyclic or heterocyclic ring which can contain from 1 to 4 heteroatoms and/or may be benzo- or naphtho-fused and/or be substituted by nonionic radicals,
R¹ and R² are each, independently of one another, hydrogen, C₁-C₆-alkyl, C₆-C₁₀-aryl or C₇-C₁₂-aralkyl,
R³ is C₁-C₁₂-alkyl, C₃-C₇-cycloalkyl, C₂-C₆-alkenyl, C₇-CI₂-aralkyl, C₆-C₁₀-aryl, C₁-C₆-alkoxy or mono-C₁-C₆-alkylamino or bis-C₁-C₆-alkylamino.

In this process of the invention, it is also possible to use two or more different azo compounds of the formula (Ic). This then gives a random mixture of metal complexes consisting of complexes containing two identical ligands of the formula (I) and complexes containing two different ligands of the formula (1). These mixtures are likewise a subject matter of the invention.

Entirely analogously, the preparation of metal complexes and the metal complexes themselves are also encompassed when a mixture of azo compounds of the formula Ic is used.

The reaction according to the invention is generally carried out in a solvent or solvent mixture, in the presence of absence of basic substances, at a temperature in the range from room temperature to the boiling point of the solvent, for example at 20-100° C., preferably 20-50° C. The metal complexes either precipitate directly and can be isolated by filtration or they are precipitated by, for example, addition of water, possibly with prior partial or complete removal of the solvent, and isolated by filtration. It is also possible to carry out the reaction directly in the solvent to give the abovementioned concentrated solutions. The anions An- can be replaced by addition of salts containing appropriate anions, e.g. the alkali metal or ammonium salts, so as to influence desired product properties such as solubility, decomposition temperature and heat of decomposition, melting point or glass transition temperature or film formation properties. This replacement of anions can also be carried out in a separate step after isolation.

For the present purposes, metal salts are, for example, the chlorides, bromides, sulphates, nitrates, hydrogensulphates, phosphates, hydrogenphosphates, dihydrogenphosphates, hydroxides, oxides, carbonates, hydrogencarbonates, salts of carboxylic acids such as formates, acetates, propionates, benzoates, salts of sulphonic acids such as methanesulphonates, trifluoromethanesulphonates or benzenesulphonates of the appropriate metals. Metal salts likewise include complexes with. ligands other than those of the formula (1), in particular complexes of acetylacetone and of acetoacetic esters. The metal salts can also be converted from lower oxidation states into the oxidation state 3 before or during the reaction with the azo compounds of the formula (Ic).

Examples of metal salts which can be used directly for the purposes of the invention are: boron trifluoride, boron triacetate, aluminium chloride, aluminium acetylacetonate, gallium chloride, hexaminecobalt(M) chloride, chromium chloride, iron chloride, iron acetylacetonate, lanthanum acetate, cerium nitrate, neodymium chloride, europium acetate, terbium acetate and also their variants containing water of crystallization.

Examples of metal salts which can be used according to the invention and have to be oxidized before or during the reaction with the azo compounds of the formula (Ic) are: cobalt acetate, iron acetate and also their variants containing water of crystallization.

Possible basic substances are alkali metal acetates such as sodium acetate, potassium acetate, alkali metal hydrogencarbonates, carbonates or hydroxides, e.g. sodium hydrogencarbonate, potassium carbonate, lithium hydroxide, sodium hydroxide, or amines such as ammonia, dimethylamine, triethylamine, diethanolamine. Such basic substances are particularly advantageous when metal salts of strong acids, e.g. metal chlorides or sulphates, are used.

Suitable solvents are water, alcohols such as methanol, ethanol, propanol, butanol, 2,2,3,3-tetrafluoropropanol, ethers such as dibutyl ether, dioxane or tetrahydrofuran, aprotic solvents such as dimethylformamide, N-methylpyrrolidone, acetonitrile, nitromethane, dimethyl sulphoxide. Preference is given to methanol, ethanol. and 2,2,3,3-tetrafluoropropanol.

Suitable oxidants are, for example,. nitric acid, nitrous acid, hydrogen peroxide, Caro's acid, alkali metal peroxodisulphates, alkali metal perborates, air, oxygen. Preference is given to nitric acid and air.

The preparation of the salt-like metal complexes of the formula (la) can also be carried out by oxidizing metal complexes in which the metal is present in a lower oxidation state, for example complexes of the formula (Id)
[(I)]₂⁻M²⁺ (Id).

The conditions of the reaction are as indicated above.

The azo compounds of the formula (Ic) required for preparing the metal complexes of the invention are largely known, e.g. from U.S. Pat. No. 5,208,325, U.S. Pat. No. 6,225,023, EP 486 995, EP 849 727, JP 2002-114922, or can be prepared by analogous methods.

The invention further provides for the use of the metal complexes of the invention as light-absorbent compounds in the information layer of write-once optical data carriers.

In this use, the optical data carriers are preferably written on and read by means of blue laser light, in particular light having a wavelength in the range 360-460 nm.

Preference is likewise given in this use to the optical data carriers being written on and read by means of read laser light, in particular light having a wavelength in the range 600-700 nm.

The invention further provides for the use of metal complexes of azo ligands as light-absorbent compound in the information layer of write-once optical data carriers which can be written on and read by means of blue laser light, in particular light having a wavelength in the range 360-460 nm.

The invention further provides an optical data carrier comprising a preferably transparent substrate which may, if desired, have previously been coated with one or more reflection layers and on whose surface a light-writeable information layer, if desired one or more reflection layers and if desired a protective layer or a further substrate or a covering layer have been applied, which can be written on and read by means of blue light, preferably light having a wavelength in the range 360-460 nm, in particular from 390 to 420 nm, very particularly preferably from 400 to 410 nm, or red light, preferably light having a wavelength in the range 600-700 nm, more preferably from 620 to 680 nm, very particularly preferably from 630 to 660 nm, preferably laser light, where the information layer comprises a light-absorbent compound and, if desired, a binder, characterized in that at least one metal complex according to the invention is used as light-absorbent compound.

The light-absorbent compound should preferably be able to be changed thermally. The thermal change preferably occurs at a temperature of <600° C., particularly preferably at a temperature of <400° C., very particularly preferably at a temperature of <300° C., in particular <200° C. Such a change can be, for example, a decomposition or chemical change of the chromophoric centre of the light-absorbent compound.

The preferred embodiments of light-absorbent compounds in the optical data carrier of the invention correspond to the preferred embodiments of the metal complex of the invention.

In a preferred embodiment, the light-absorbent compounds used are compounds of the formula (Ia), (Ib), (IIa) or (IIb),

where

X¹ is O, S, N—R¹ or CH,
A together with X¹ and N forms a five- or six-membered aromatic or pseudoaromatic heterocyclic ring which contains from 1 to 4 heteroatoms and/or may be benzo- or naphtho-fused and/or substituted by nonionic radicals,
Y¹ is O, S, N—R², COO, SO₃, N—CO—R³ or N—SO₂—R³,
B is a five- or six-membered carbocyclic or heterocyclic ring which may contain from 1 to 4 heteroatoms and/or may be benzo- or naphtho-fused and/or substituted by nonionic radicals,
R¹ and R² are each, independently of one another, hydrogen, C₁-C₆-alkyl, C₆-C₁₀-aryl or C₇-C₁₂-aralkyl,
R³ is C₁-C₁₂-alkyl, C₃-C₇-cycloalkyl, C₂-C₆-alkenyl, C₇-C₁₂-aralkyl, C₆-C₁₀-aryl, C₁-C₆-alkoxy or mono-C₁-C₆-alkylamino or bis-C₁-C₆-alkylamino,
M is a metal,
An⁻ is an anion,
Z is halogen, CN, R⁴—O—, R⁴—S—, R⁴—SO₂—, R⁴—CO—O—, R⁴—SO₂—O—, R⁴—CO—NH— or R⁴—SO₂—NH and
R⁴ is C₁-C₆-alkyl, C₃-C₇-cycloalkyl, C₇-C₁₂-aralkyl or C₆-C₁₀-aryl.

In a particularly preferred embodiment, the light-absorbent compounds used are compounds of the formula (Ia), (Ib), (IIa) or (IIb),
in which the ring A of the formula 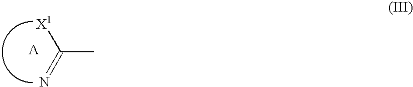
is benzothiazol-2-yl, benzoxazol-2-yl, benzimidazol-2-yl, thiazol-2-yl, thiazol-4-yl, imidazol-2-yl, pyrazol-5-yl, 1,3,4-thiadiazol-2-yl, 1,2,4-thiadiazol-5-yl, 1,2,4-thiadiazol-3-yl, 1,3,4-oxadiazol-2-yl, 1,3,4-triazol-2-yl, 2-pyridyl, 2quinolyl, 3-pyridazinyl, 2-pyrimidyl, 1,3,5-triazin-2-yl or 2-pyrazinyl, each of which may be substituted by C₁-C₆-alkyl, C₁-C₆-alkoxy, fluorine, chlorine, bromine, iodine, cyano, —C(═NH)—O—C₁-C₆-alkyl, nitro, C₁-C₆-alkoxycarbonyl, C₁-C₆-alkyl-thio, C₁-C₆-acylamino, C₆-C₁₀-aryl, C₆-C₁₀-aryloxy, C₆-C₁₀-arylcarbonylamino, mono-C₁-C₆-alkylamino or di-C₁-C₆-alkylamino, N—C₁-C₆-alkyl-N—C₆-C₁₀-arylamino, pyrrolidino, morpholino, piperazino or piperidino,
where
X¹ is O, S, N—R¹ or CH,
the ring B of the formula 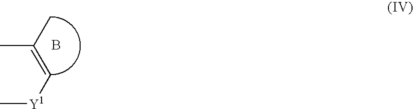
is a radical of one of the formulae 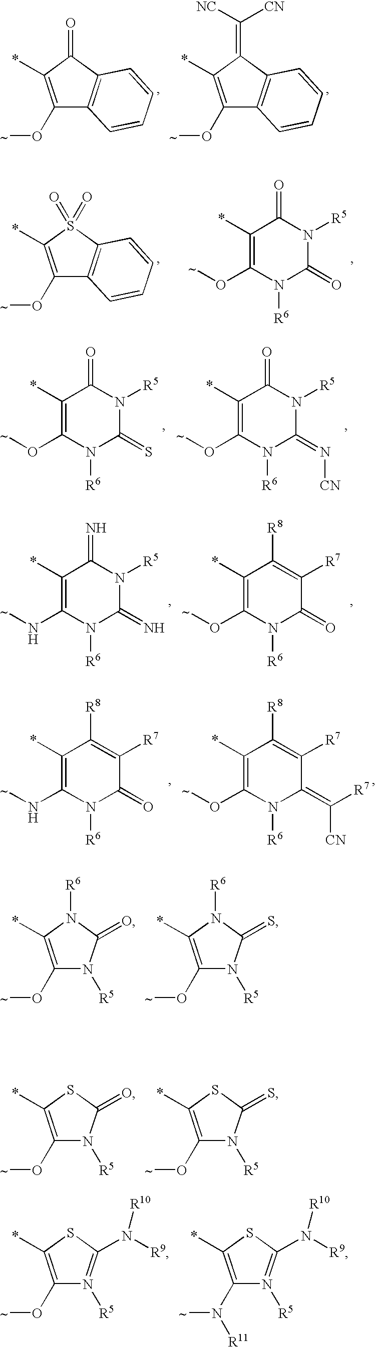 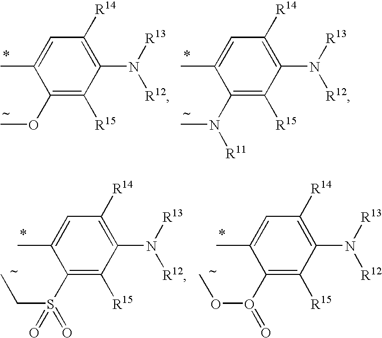
R¹ is hydrogen, methyl, ethyl, propyl, butyl, benzyl or phenethyl,
R⁵ and R⁶ are each, independently of one another, hydrogen, methyl, ethyl, propyl, butyl, benzyl, phenethyl, cyclopentyl, cyclohexyl, phenyl, tolyl, methoxyphenyl or chlorophenyl,
R⁷ is cyano, methoxycarbonyl, ethoxycarbonyl or a radical of the formula 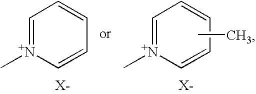
R⁸ is hydrogen, methyl, ethyl, trifluoromethyl, cyano, methoxycarbonyl or ethoxycarbonyl,
R⁹, R¹⁰, R¹² and R¹³ are each, independently of one another, hydrogen, methyl, ethyl, propyl, butyl, cyanoethyl, hydroxyethyl, methoxyethyl, chloroethyl, benzyl, phenethyl, cyclopentyl, cyclohexyl, phenyl, tolyl, methoxyphenyl or chlorophenyl or
NR⁹R¹⁰ and NR¹²R¹³ are each, independently of one another, pyrrolidino, piperidino, piperazino or morpholino,
R¹⁴ and R¹⁵ are each, independently of one another, hydrogen, methyl, ethyl, methoxy or chlorine or
R¹²; R¹⁵ and R¹³; R¹⁴ may in each case form, independently of one another, a —(CH₂)₂—, —(CH₂)₃—, —(CH₂)₂—O— bridge which may be substituted by up to three methyl groups,
R¹¹ is hydrogen, methyl, ethyl, 2,2,3,3-tetrafluoropropyl, formyl, acetyl, trifluoroacetyl, propionyl, butanoyl, benzoyl, pyridoyl, methanesulphonyl, trifluoromethanesulphonyl, ethanesulphonyl, 2,2-difluoroethanesulphonyl, 2,2,2-trifluoroethanesulphonyl, perfluoro butanesulphonyl, benzenesulphonyl, chlorobenzenesulphonyl or toluenesulphonyl,
An⁻ is an anion,
Z is fluorine, chlorine, bromine, CN, acetate, benzoate, methoxy, methylthio or benzenesulphinate,
M is B, Al, Ga, Co, Cr, Fe, Y, La or Ce,
the asterisked (*) bond leads to the azo group and
the bond denoted by “˜” leads to the metal M.

In a very particularly preferred embodiment, the light-absorbent compounds used are compounds of the formula (Ia), (Ib), (Ia) or (IIb),

in which

the ring A of the formula (III) 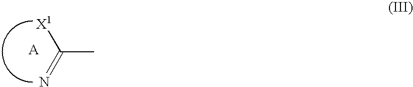
is benzothiazol-2-yl, chlorobenzothiazol-2-yl, methylbenzothiazol-2-yl, methoxybenzothiazol-2-yl or nitrobenzothiazol-2-yl, benzimidazol-2-yl, thiazol-2-yl, phenylthiazol-2-yl, cyanothiazol-2-yl, nitrothiazol-2-yl, 5-fluoro4trifluoromethylthiazol-2-yl, 5-phenyl4-trifluoromethyl-thiazol-2-yl, 2-methylthio-5-cyanothiazol4yl, imidazol-2-yl, 4,5-diphenylimidazol-2-yl, 4,5-dicyanoimidazol-2-yl, 4,5-bismethoxy-carbonylimidazol-2-yl or 4,5-bisethoxycarbonylimidazol-2-yl, pyrazol-5-yl, 1,3,4-thiadiazol-2-yl, 5-phenoxy-1,3,4-thiadiazol-2-yl, 5-methylthio-1,3,4-thiadiazol-2-yl, 5dimethylamino-1,3,4-thiadiazol-2-yl, 5-diethylamino-1,3,4-thiadiazol-2-yl, 54di(iso)propylamino-1,3,4-thiadiazol-2-yl, 5-N-methyl-N-cyanoethylamino-1,3,4-thiadiazol-2-yl, 5-pyrrolidino-1,3,4-thiadiazol-2-yl, 5-phenyl-1,3,4-thiadiazol-2-yl, 5-methyl-1,3,4-thiadiazolyl, 1,2,4-thiadiazol-5-yl, 3-methylthio-1,2,4-thiadiazol-5-yl, 3-methanesulphonyl-1,2,4-thiadiazol-5-yl, 3-phenyl-1,2,4-thiadiazol-5-yl, 5-methyl-1,2,4-thiadiazol-3-yl, 1,3,4-triazol-2-yl, 2-pyridyl, 2-quinolyl, 2-pyrimidyl, 4-cyano 2-pyrimidyl, 4,6-dicyano-2-pyrimidyl, 1,3,5-triazin-2-yl or 2-pyrazinyl,
where
X¹ is O, S, N—R¹ or CH,

R¹ is hydrogen, methyl, ethyl or benzyl,

the ring B of the formula (IV) 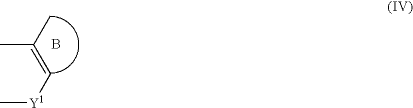
is a radical of one of the formulae 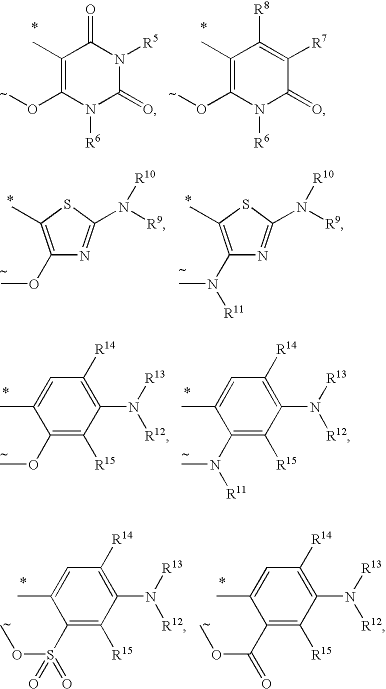
R⁵ and R⁶ are each, independently of one another, hydrogen, methyl or ethyl,
R⁷ is cyano or methoxycarbonyl,
R⁸ is hydrogen, methyl, trifluoromethyl or cyano,
R⁹, R¹⁰, R¹² and R¹³ are each, independently of one another, hydrogen, methyl, ethyl, propyl, butyl, cyanoethyl, methoxyethyl, chloroethyl, benzyl, cyclohexyl, phenyl, tolyl or methoxyphenyl or
NR⁹R¹⁰ and NR¹²R¹³ are each, independently of one another, pyrrolidino, piperidino or morpholino,
R¹⁴ and R¹⁵ are each, independently of one another, hydrogen, methyl or methoxy or
R¹²; R¹⁵ and R¹³; R¹⁴ in each case form, independently of one another, a —(CH₂)₂— or —(CH₂)₃— bridge,
R¹¹ is 2,2,3,3-tetrafluoropropyl, acetyl, propionyl, benzoyl, pyridoyl, methanesulphonyl, trifluoromethanesulphonyl, ethanesulphonyl, perfluorobutanesulphonyl or benzenesulphonyl,
An⁻ is tetrafluoroborate, perchlorate, hexafluorophosphate, iodide, nitrate, methoxyacetate, methanesulphonate, ethanesulphonate, trifluoromethanesulphonate, benzenesulphonate, toluenesulphonate, butylbenzenesulphonate, chlorobenzenesulphonate, dodecylbenzene sulphonate, naphthalenesulphonate, an equivalent of polystyrenesulphonate or the anion of the formula 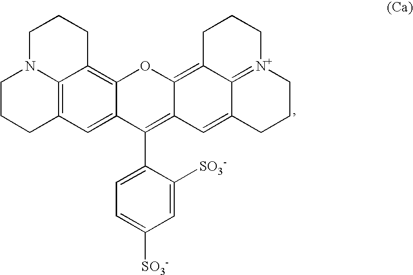
Z is fluorine,
M is B, Al or Co,
the asterisked (*) bond leads to the azo group and
the bond denoted by “˜” leads to the metal M.

In an especially preferred embodiment, the light-absorbent compounds used are compounds of the formula (Ia) or (IIa),

in which

the ring A of the formula (III) 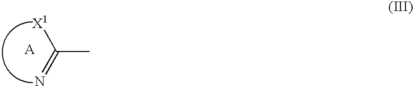
is 4,5-dicyanoimidazol-2-yl, 1-methyl4,5-dicyanoimidazol-2-yl, 1-ethyl4,5-dicyanoimidazol-2-yl, 1-benzyl4,5-dicyanoimidazol-2-yl, 1-(2,2,2-trifluoroethyl)4,5-dicyanoimidazol-2-yl, 3-phenyl-1,2,4-thiadiazol-2-yl, 3-methanesulphonyl-1,2,4-thiadiazol-2-yl, 5-dimethylamino-1,3,4-thiadiazol-2-yl, 5-diisopropylamino-1,3,4-thiadiazol-2-yl, 5-pyrrolidino-1,3,4-thiadiazol-2-yl, 5-phenyl-1,3,4-thiadiazol-2-yl, 5-methyl-1,3,4-thiadiazol-2-yl, 2-pyridyl, 2-pyrimidyl, 4-cyano-2-pyrimidyl,

the ring B of the formula (IV) 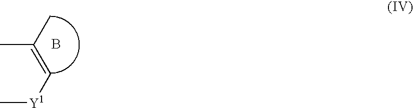
is a radical of the formula 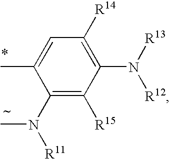
R¹² and R¹³ are each, independently of one another, hydrogen, methyl, ethyl, propyl, cyanoethyl, benzyl, cyclohexyl or phenyl or
NR¹²R¹³ is pyrrolidino, piperidino or morpholino,
R¹⁴ and R¹⁵ are each hydrogen or
R¹²; R¹⁵ and R¹³; R¹⁴ may in each case form, independently of one another, a —(CH₂)₂— or —(CH₂)₃— bridge,
R¹¹ is methanesulphonyl, trifluoromethanesulphonyl or perfluorobutanesulphonyl,
An⁻ is tetrafluoroborate, perchlorate, hexafluorophosphate, iodide, nitrate, trifluoromethanesulphonate or the anion of the formula 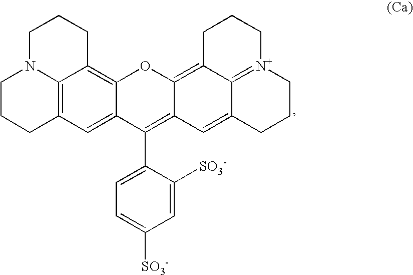
M is Co,
the asterisked (*) bond leads to the azo group and
the bond denoted by “˜” leads to the metal M.

In the case of a write-once optical data carrier according to the invention which is written on and read by means of the light of a blue laser, preference is given to light-absorbent compounds whose absorption maximum λₘₐₓ₂ is in the range from 420 to 550 nm, where the wavelength λ_{1/2} at which the absorbance in the short wavelength flank of the absorption maximum at the wavelength λₘₐₓ₂ is half of the absorbance value at λₘₐₓ₂ and the wavelength λ_{1/10} at which the absorbance in the short wavelength flank of the absorption maximum at the wavelength λₘₐₓ₂ is one tenth of the absorbance value at λₘₐₓ₂ are preferably not more than 80 nm apart. Such a light-absorbent compound preferably has no shorter-wavelength maximum λₘₐₓ₁ down to a wavelength of 350 nm, particularly preferably down to 320 nm, very particularly preferably down to 290 nm.

Preference is given to light-absorbent compounds having an absorption maximum λₘₐₓ₂ of from 430 to 550 nm, in particular from 440 to 530 nm, very particularly preferably from 450 to 520 nm.

In these light-absorbent compounds, λ_{1/2} and λ_{1/10}, as defined above, are preferably not more than 70 nm apart, particularly preferably not more than .50 nm apart, very particularly preferably not more than 40 nm apart.

In the case of a write-once optical data carrier according to the invention which is written on and read by means of the light of a red laser, preference is given to light-absorbent compounds whose absorption maximum λₘₐₓ₂ is in the range from 500 to 650 nm, where the wavelength λ_{1/2} at which the absorbance in the long wavelength flank of the absorption maximum at the wavelength λₘₐₓ₂ is half of the absorbance value at λₘₐₓ₂ and the wavelength λ_{1/10} at which the absorbance in the long wavelength flank of the absorption maximum at the wavelength λₘₐₓ₂ is one tenth of the absorbance value at λₘₐₓ₂ are preferably not more than 60 nm apart. Such a light-absorbent compound preferably has no longer-wavelength maximum , up to a wavelength of 750 nm, particularly preferably up to 800 nm, very particularly preferably up to 850 nm.

Preference is given to light-absorbent compounds having an absorption maximum λₘₐₓ₂ of from 510 to 620 nm.

Particular preference is given to light-absorbent compounds having an absorption maximum λₘₐₓ₂ of from 530 to 610 nm.

Very particular preference is given to light-absorbent compounds having an absorption maximum λₘₐₓ₂ of from 550 to 600 nm.

In these light-absorbent compounds, λ_{1/2} and λ_{1/10} as defined above, are preferably not more than 50 nm apart, particularly preferably not more than 40 nm apart, very particularly preferably not more than 30 nm apart.

The light-absorbent compounds preferably have a molar extinction coefficient ε of >30 000 l/mol cm, preferably >50 000 l/mol cm, particularly preferably >70 000 l/mol cm, very particularly preferably >100 000 l/mol cm, at the absorption maximum λₘₐₓ₂.

The absorption spectra are measured, for example, in solution.

Suitable light-absorbent compounds, having the required spectral properties are, in particular, those which have a low solvent-induced wavelength shift (dioxane/DMF or methylene chloride/methanol). Preference is given to metal complexes whose. solvent-induced wavelength shift Δλ_{DD}=|λ_{DMF}−λ_{dioxane}|, i.e. the positive difference between the absorption wavelengths in the solvents dimethylformamide and dioxane, or whose solvent-induced wavelength shift Δλ_{MM}=|λₘₑₜₕₐₙₒₗ−λ_{methylene chloride}|, i.e. the positive difference between the absorption wavelengths in the solvents methanol and methylene chloride, is <20 nm, particularly preferably <10 nm, very particularly preferably <5 nm.

Preference is given to a write-once optical data carrier according to the invention which is written on and read by means of the light of a red or blue laser, in particular a red laser.

The azo metal complexes of the invention can also be mixed with other light-absorbent compounds. For this purpose, preference is given to light-absorbent compounds having similar spectral properties. Such light-absorbent compounds can come, for example, from the following classes of dyes: cyanines, (diaza)hemicyanines, merocyanines, rhodamines, azo dyes, porphyrins, phthalocyanines, subphthalocyanines, azo metal complexes. Preference is given to other azo metal complexes.

Other metal complexes are known, for example, from US-B1 6,225,023.

The light-absorbent substances used according to the invention guarantee a sufficiently high reflectivity (>10%, in particular >20%) of the optical data carrier in the unwritten state and a sufficiently high absorption for thermal degradation of the information layer on point-wise illumination with focussed light if the wavelength of the light is in the range from 360 to 460 nm and from 600 to 680 nm. The contrast between written and unwritten points on the data carrier is achieved by the reflectivity change of the amplitude and also the phase of the incident light due to the changed optical properties of the information layer after thermal degradation.

The light-absorbent compounds used according to the invention display a high light stability of the unwritten optical data carrier and of the information written on the data carrier against daylight, sunlight or strong artificial illumination in imitation of daylight.

The light-absorbent compounds used according to the invention likewise display a high sensitivity of the optical data carrier to blue and red laser light of sufficient energy, so that the data carrier can be written on at high speed (≧2×, ≧4×).

The light-absorbent compounds used according to the invention are stable enough for the disc produced using them to generally pass the required climate test.

The azo metal dyes of the invention are preferably applied to the optical data carrier by spin coating or vacuum vapour deposition. The azo metal dyes can be mixed with one another or else with other dyes having similar spectral properties. In particular, dyes having various anions can also be mixed. The information layer can comprise not only the azo metal dyes but also additives such as binders, wetting agents, stabilizers, diluents and sensitizers and also further constituents.

Apart from the information layer, further layers such as metal layers, dielectric layers, barrier layers and protective layers may be present in the optical data carrier. Metals and dielectric and/or barrier layers serve, inter alia, to adjust the reflectivity and the heat absorption/retention. Metals can be, depending on the laser wavelength, gold, silver, aluminium, etc. Examples of dielectric layers are silicon dioxide and silicon nitride. Barrier layers are dielectric or metal layers. Protective layers are, for example, photocurable surface coatings, adhesive layers and protective films.

Pressure-sensitive adhesive layers consist mainly of acrylic adhesives. Nitto Denko DA-8320 or DA-8310, disclosed in the patent JP-A 11-273147, can, for example, be used for this purpose.

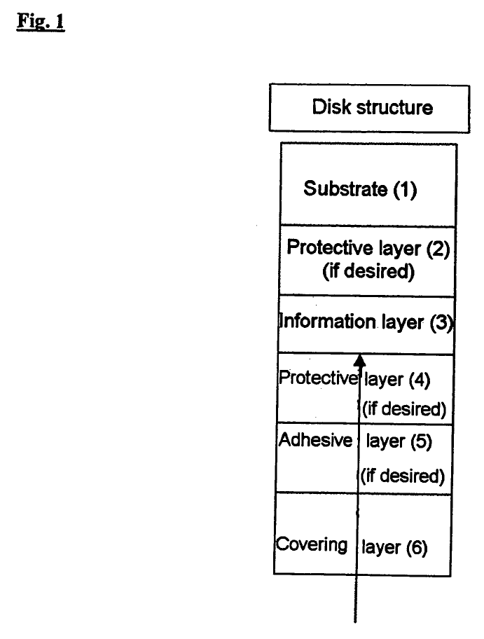

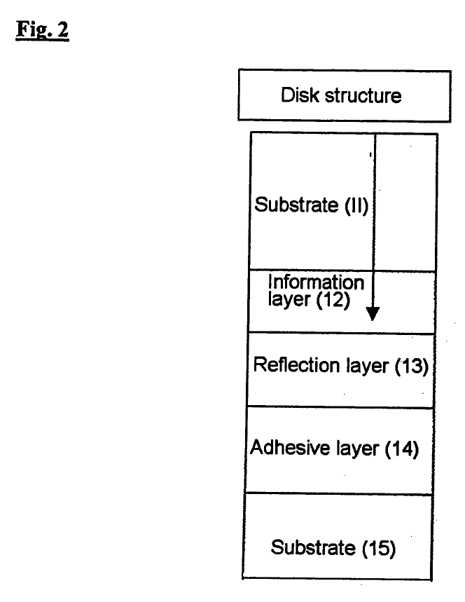

The optical data carrier of the invention has, for example, the following layer structure (cf. FIG. 1): a transparent substrate (1), if desired a protective layer (2), an information layer (3), if desired a protective layer (4), if desired an adhesive layer (5), a covering layer (6). The arrows shown in FIG. 1 and FIG. 2 indicate the path of the incident light.

The structure of the optical data carrier preferably:
comprise a preferably transparent substrate (1) to whose surface at least one light-writeable information layer (3) which can be written on by means of light, preferably laser light, if desired a protective layer (4), if desired an adhesive layer (5) and a transparent covering layer (6) have been applied.
comprise a preferably transparent substrate (1) to whose surface a protective layer (2), at least one information layer (3) which can be written on by means of light, preferably laser light, if desired an adhesive layer (5) and a transparent covering layer (6) have been applied.
comprise a preferably transparent substrate (1) to whose surface a protective layer (2) if desired, at least one information layer (3) which can be written on by means of light, preferably laser light, if desired a protective layer (4), if desired an adhesive layer (5) and a transparent covering layer (6) have been applied.
comprise a preferably transparent substrate (1) to whose surface at least one information layer (3) which can be written on by means of light, preferably laser light, if desired an adhesive layer (5) and a transparent covering layer (6) have been applied.

Alternatively, the optical data carrier has, for example, the following layer structure (cf. FIG. 2): a preferably transparent substrate (11), an information layer (12), if desired a reflection layer (13), if desired an adhesive layer (14), a further preferably transparent substrate (15).

The invention further provides optical data carriers according to the invention which have been written on by means of blue or red light, in particular laser light, in particular red laser light.

The following examples illustrate the subject-matter of the invention.

### EXAMPLES

### Example 1

1.2 g of cobalt(II) acetate tetrahydrate were dissolved in 20 ml of acetonitrile and admixed with 0.5 ml of 65 per cent strength nitric acid. After stirring at room temperature for 1 hour, this solution was added to a solution of 4.4 g of the azo dye of the formula

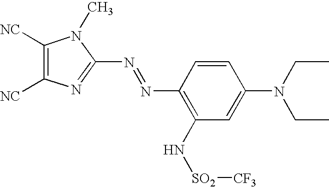

(prepared as described in U.S. Pat. No. 6,225,023) in 40 ml of acetonitrile. The mixture was stirred at 60° C. for 5 hours, cooled and poured into a solution of 2 g of lithium perchlorate in 60 ml of water. After stirring for 1 hour, the mixture was filtered with suction, the solid was washed with 2×20 ml of water and dried at 40° C. under reduced pressure. The crude metal complex was stirred with 25 ml of toluene at room temperature, filtered off with suction and dried at 40° C. under reduced pressure. This gave 4.14 g (81% of theory) of the metal complex of the formula

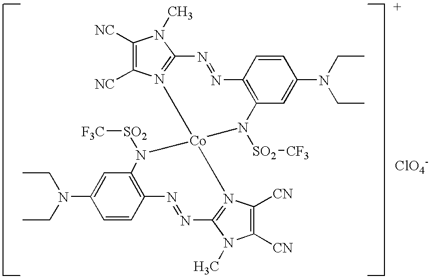

as a violet powder having a melting point of 265° C.

Electrospray mass spectrum: m/e=965.15

λₘₐₓ=556, 584 nm (in dichloromethane)

ε=92575 l/mol cm (at 584 nm)

λ_{1/2}-λ_{1/10} (long wavelength flank)=35 nm

Solubility: >2% in TFP (2,2,3,3-tetrafluoropropanol)

Vitreous film

### Example 2

a) 7.9 g of 3-phenyl-5-amino-1,2,4-thiadiazole were dissolved in a mixture of 30 ml of glacial acetic acid and 15 ml of formic acid with gentle heating.

After cooling to 0° C., 3.1 g of sodium nitrite were introduced over a period of 15 minutes. The mixture was stirred at 0-5° C. for 2 hours. A solution of 15.9 g of 3-methanesulphonylamino-N,N-diethylaniline in 15 ml of glacial acetic acid was then added dropwise at this temperature over a period of 30 minutes.

The mixture was allowed to come to room temperature and was subsequently heated at 90° C. for 1 hour. It was stirred at this temperature for 1 hour, cooled to room temperature, filtered with suction and the solid was washed with 10 ml of methanol and 10 ml of water. Drying at 50° C. under reduced pressure gave 5.5 g (29% of theory) of a red powder having the formula 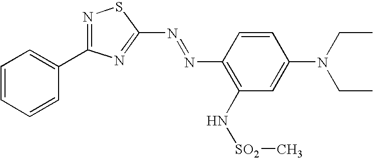
and a melting point of 213° C.
λₘₐₓ=517 nm (in dichloromethane)
ε=50040 l/mol cm.
b) 1.2 g of cobalt(II) acetate tetrahydrate were dissolved in 20 ml of acetone and admixed with 0.5 ml of 65 per cent strength nitric acid. After stirring at room temperature for 1 hour, this solution was added to a solution of 4.16 g of the azo dye from a) in 20 ml of acetone. The mixture was stirred at 60° C. for 3 hours, cooled and poured into 60 ml of water. After stirring for 1 hour, the mixture was filtered with suction, the solid was washed with 2×20 ml of water and dried at 40° C. under reduced pressure. The crude metal complex was stirred with 25 ml of toluene at room temperature, filtered off with suction and dried at 40° C. under reduced pressure. This gave 4.0 g (80% of theory) of the metal complex of the formula 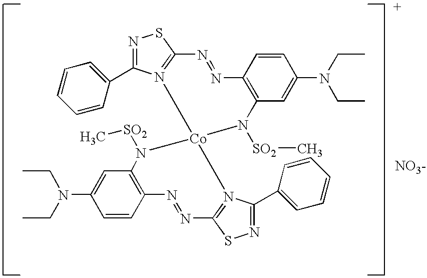
as a violet powder.
λₘₐₓ=548 nm (in methanol)
ε=78980 l/mol cm
λ_{1/2}-λ_{1/10} (long wavelength flank)=36 nm
Solubility: >2% in TFP (2,2,3,3-tetrafluoropropanol)
Vitreous film
c) 1 g of the metal complex from b) was dissolved in 20 ml of water and precipitated by addition of 0.3 g of lithium perchlorate. This gave 0.7 g of the metal complex of the formula 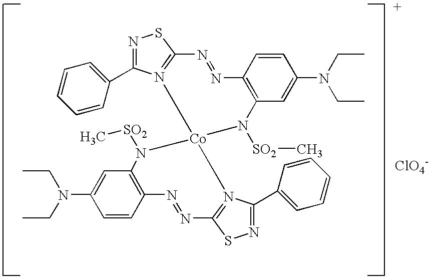
as a violet powder.
Electrospray mass spectrum: m/e=917.17
λₘₐₓ=548 nm (in methanol)
ε=78972 l/mol cm
λ_{1/2}-λ_{1/10} (long wavelength flank)=36 nm
Solubility: >2% in TFP (2,2,3,3-tetrafluoropropanol)
Vitreous film

### Example 3

0.14 g of cobalt(H) acetate tetrahydrate and 0.4 g of the azo dye from Example 2a) were dissolved in 20 ml of N-methylpyrrolidone. At 60° C., a gentle stream of air was passed through the solution for 5 hours while stirring. After cooling, the solution was diluted with 100 ml of water and extracted with 2×20 ml of methylene chloride. The organic phase was evaporated on a rotary evaporator and the oily residue was taken up in 5 ml of water. The crystals formed in this way were filtered off with suction. The mother liquor was admixed with 0.5 g of lithium perchlorate. After stirring for 1 hour, the mixture was filtered with suction and the solid was dried at 40° C. under reduced pressure. This gave 0.3 g (57% of theory) of the metal complex of Example 2c).

### Example 4

A solution of 1 g of the metal complex from Example 2b in 20 ml of water was introduced into a solution of 0.63 g of the rhodamine dye of the formula 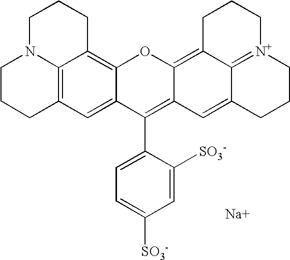
in 23 ml of water. The mixture was stirred overnight at room temperature, filtered with suction and the solid was washed with 2×50 ml of water. This gave 0.9 g (59% of theory) of the metal complex of the formula

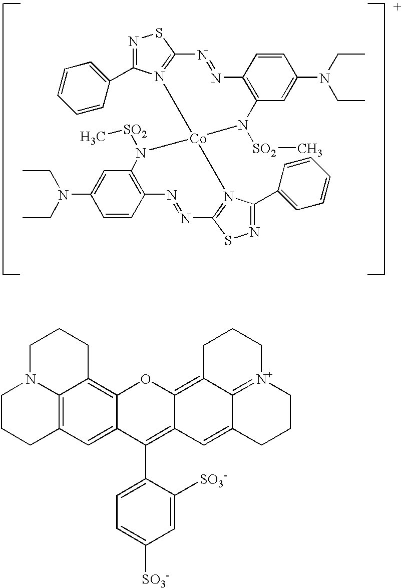

as a violet powder.

λₘₐₓ=573 nm (in dichloromethane)

ε=174540 l/mol cm λ_{1/2}-λ_{1/10} (long wavelength flank)=41 nm

Δλ=|λ_{methylene chloride}-λₘₑₜₕₐₙₒₗ|=1 nm

Solubility: >2% in TFP (2,2,3,3-tetrafluoropropanol)

Vitreous film

### Example 5

The metal complex of the formula

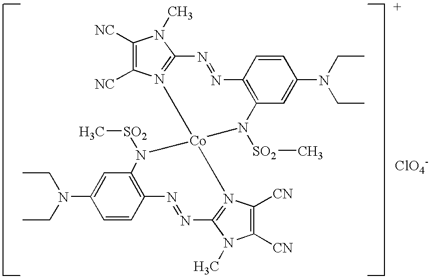

was prepared as a violet powder in a yield of 62% by a procedure analogous to that of Example 1 but using acetone instead of acetonitrile as solvent.

λₘₐₓ=553, 580 nm (in dichioromethane)

ε=85738 U/mol cm (at 553 nm)

Solubility: >2% in ThP (2,2,3,3-tetrafluoropropanol)

Vitreous film

### Example 6

The metal complex of the formula

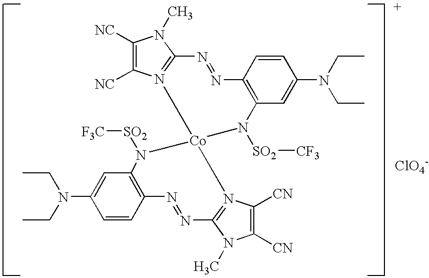

was prepared as a violet powder in a yield of 80% by a procedure analogous to Example 1 but using acetone instead of acetonitrile as solvent.

Electrospray mass spectrum: m/e=829

λₘₐₓ=558, 592 nm (in methanol)

ε=71866 l/mol cm (at 558 nm)

Solubility: >2% in TFP (2,2,3,3-tetrafluoropropanol)

Vitreous film

### Example 7

The metal complex of the formula

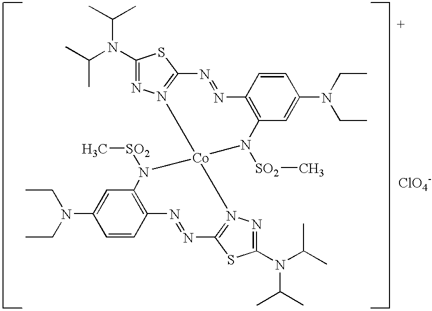

was prepared as a blue powder in a yield of 78% by a procedure analogous to Example 1.

Solubility: >2% in TFP (2,2,3,3-tetrafluoropropanol)

Vitreous film

Azo metal dyes which are likewise suitable are shown in the following table:

| Example | 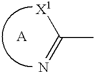 | 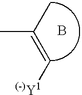 | M | An⁻ |
|---|---|---|---|---|
| 8 | 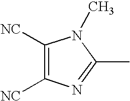 | 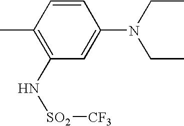 | Co | NO₃⁻ |
| 9 | 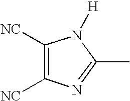 | 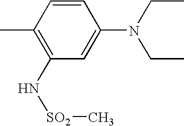 | Co | BF₄⁻ |
| 10 | 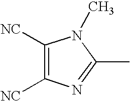 | 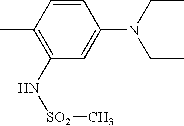 | Co | 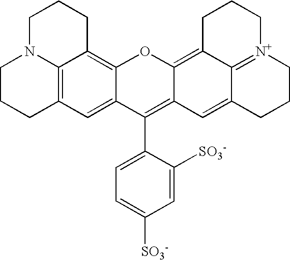 |
| 11 | 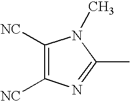 | 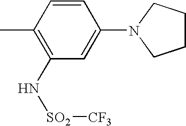 | Co | PF₆⁻ |
| 12 | 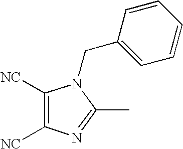 | 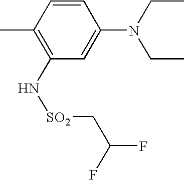 | Co | ClP₄⁻ |
| 13 | 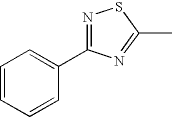 | 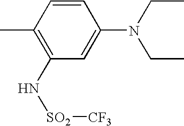 | Co | CF₃SO₃⁻ |
| 14 | 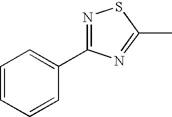 | 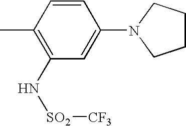 | Co | ClO₄⁻ |
| 15 | 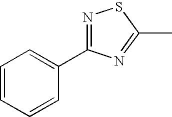 | 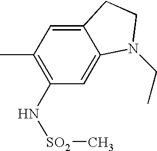 | Co | NO₃⁻ |
| 16 | 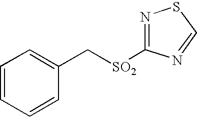 | 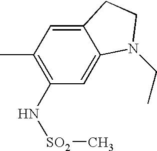 | Co | NO₃⁻ |
| 17 | 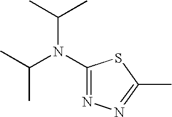 | 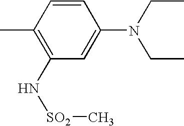 | Co | ClO₄⁻ |
| 18 | 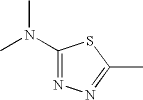 | 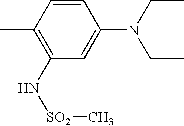 | Co | ClO₄⁻ |
| 19 | 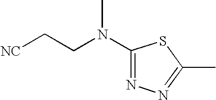 | 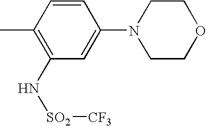 | Co | PF₆⁻ |
| 20 | 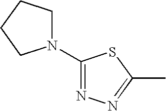 | 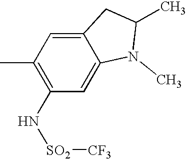 | Co | 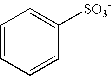 |
| 21 | 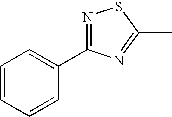 | 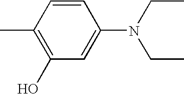 | Co | 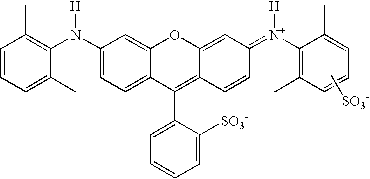 |
| 22 | 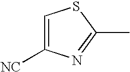 | 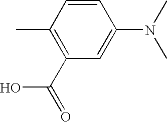 | Co | ClO₄⁻ |
| 23 | 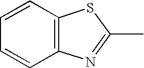 | 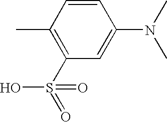 | Co | ClO₄⁻ |
| 24 | 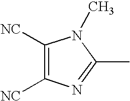 | 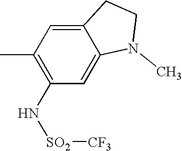 | Co | 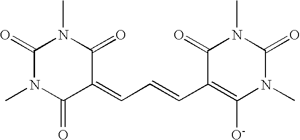 |
| 25 | 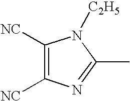 | 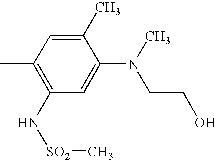 | Co | NO₃⁻ |
| 26 | 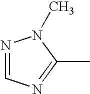 | 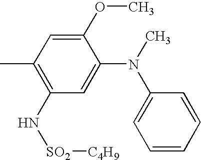 | Co | NO₃⁻ |
| 27 | 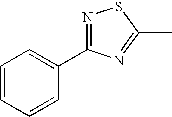 | 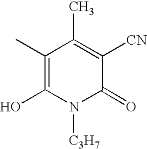 | Co | BF₄⁻ |
| 28 | 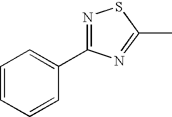 | 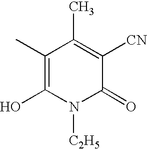 | B—F | |
| 29 | 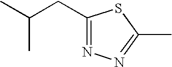 | 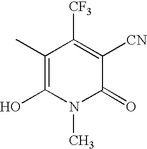 | B—O—COCH₃ | |
| 30 | 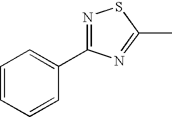 | 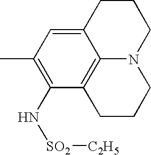 | Co | ClO₄⁻ |
| 31 | 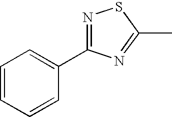 | 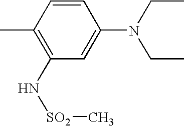 | Co | 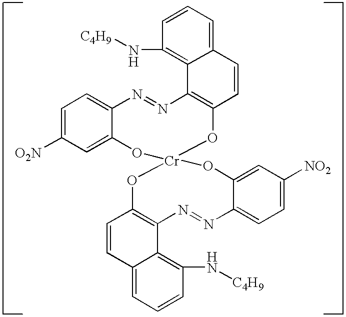 |
| 32 | 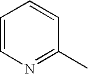 | 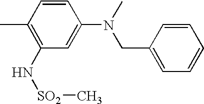 | Co | ClO₄⁻ |
| 33 | 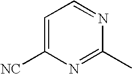 | 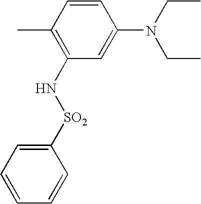 | Co | ClO₄⁻ |
| 34 | 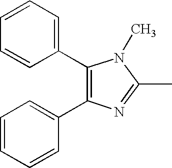 | 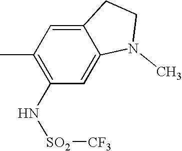 | Co | ClO₄⁻ |
| 35 | 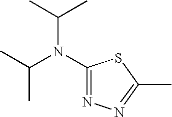 | 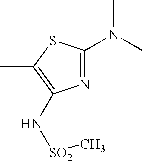 | Co | ClO₄⁻ |
| 36 | 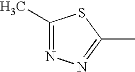 | 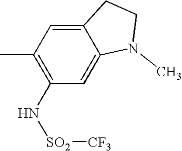 | Co | ClO₄⁻ |
| 37 | 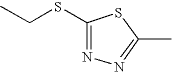 | 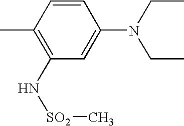 | Co | ClO₄⁻ |
| 38 | 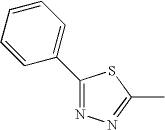 | 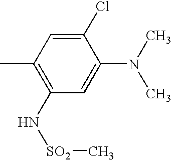 | Co | ClO₄⁻ |
| 39 | 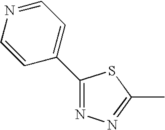 | 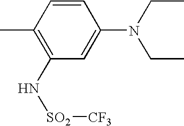 | Co | ClO₄⁻ |
| 40 | 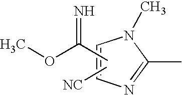 | 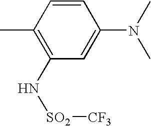 | Co | BF₄⁻ |

### Example 41

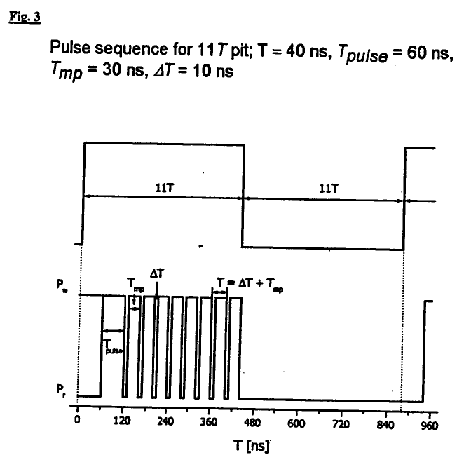

A solution of 2 g of the dye from Example 1 in 100 ml of 2,2,3,3-tetrafluoropropanol was prepared at room temperature. This solution was applied by means of spin coating to a pregrooved polycarbonate substrate. The pregrooved polycarbonate substrate had been produced as a disc by means of injection moulding. The dimensions of the disk and the groove structure corresponded to those customarily used for DVD-Rs. The disk with the dye layer as information carrier was coated with 100 nm of silver by vapour deposition. A UV-curable acrylic coating composition was subsequently applied by spin coating and cured by means of a UV lamp: The disk was tested by means of a dynamic writing test apparatus constructed on an optical test bench comprising a diode laser (λ=656 nm) for generating linearly polarized light, a polarization-sensitive beam splitter, a λ/4 plate and a movably suspended collecting lens having a numerical aperture NA=0.6 (actuator lens). The light reflected from the reflection layer of the disk was taken out from the beam path by means of the abovementioned polarization-sensitive beam splitter and focussed by means of an astigmatic lens onto a four-quadrant detector. At a linear velocity V=3.5 m/s and a writing power P_{w}=10 mW, a signal/noise ratio C/N=48.4 dB was measured for 11T pits. The writing power was applied as an oscillating pulse sequence (cf. FIG. 3), with the disk being irradiated alternatively with the abovementioned writing power P_{w} and the reading power Pᵣ=0.5 mW. The writing pulse sequence for the 11T pit comprised a lead pulse of length 1.5T=60 ns, where top T=40 ns the base time (11T=440 ns). The lead pulse was placed such that it ended after 3T units. This was followed by eight pulses of length Tₘₚ=30 ns, with the time being defined by Tₘₚ=0.75T. A time interval AT=10 ns therefore remains. free between each writing pulse. The 11T long writing pulse was followed by a 11T long pause. The disk was irradiated with this oscillating pulse sequence until it had rotated once. The marking produced in this way was then read using the reading power Pᵣ and the abovementioned signal/noise ratio C/N was measured.

Analogous results were obtained using the metal complexes from the other examples described above.

1. Metal complexes which have at least one ligand of the formula (I) 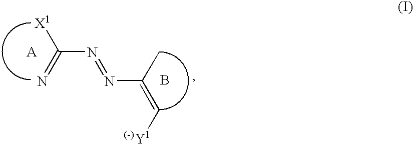
where
X¹ is O, S, N—R¹ or CH,
A together with X¹ and N forms a five- or six-membered aromatic or pseudoaromatic heterocyclic ring which contains from 1 to 4 heteroatoms and/or may be benzo- or naphtho-fused and/or substituted by nonionic radicals,
Y¹ is O, S, N—R², COO, SO₃, N—CO—R³ or N—SO₂—R³,
B is a five- or six-membered carbocyclic or heterocyclic ring which may contain from 1 to 4 heteroatoms and/or may be benzo- or naphtho-fused and/or substituted by nonionic radicals,
R¹ and R² are each, independently of one another, hydrogen, C₁-C₆-alkyl, C₆-C₁₀-aryl or C₇-C₁₂-aralkyl,
R³ is C₁-C₁₂-alkyl, C₃-C₇-cycloalkyl, C₂-C₆-alkenyl, C₇-C₁₂-aralkyl, C₆-C₁₀-aryl, C₁-C₆-alkoxy or mono-C₁-C₆-alkylamino or bis-C₁-C₆-alkylamino.

2. Metal complexes according to claim 1, characterized in that they contain two identical or different ligands of the formula (I).

3. Metal complexes according to claim 1, which have the formula (Ia)
[(I)]₂⁻ M³⁺ An⁻ (Ia)
where the two ligands of the formula (1) are each, independently of one another, as defined above,
M is a metal and
An⁻ is an anion.

4. Metal complexes according to claim 1, which have the formula (Ib)
[(I)]₂⁻ M²⁺−Z (Zb)
where the two ligands of the formula (I) are, independently of one another, as defined above,
M is a metal,
Z is halogen, CN, R⁴—O—, R⁴—S—, R⁴—SO₂—, R⁴—CO—O—, R⁴—SO₂—O—, R⁴—CO—NH— or R⁴—SO₂—NH— and
R⁴ is C₁-C₆-alkyl, C₃-C₇-cycloalkyl, C₇-C₁₂-aralkyl or C₆-C₁₀-aryl.

5. Metal complexes according to claim 1, characterized in that the metal is a trivalent metal, transition metal or rare earth, in particular B, Al, Ga, In, V, Co, Cr, Fe, Y, La, Ce, Pr, Nd, Sm, Eu, Gd, Th.

6. Metal complexes according to claim 1, characterized in that the metal is B, Al or Co.

7. Metal complexes according to at least one of claims 1 to 6, characterized in that, in the formula (I),
the ring A of the formula 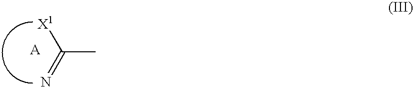
is benzothiazol-2-yl, benzoxazol-2-yl, benzimidazol-2-yl, thiazol-2-yl, thiazolyl, imidazol-2-yl, pyrazol-5-yl, 1,3,4-thiadiazol-2-yl, 1,2,4-thiadiazol-5-yl, .1,2,4-thiadiaz6l-3-yl, 1,3,4-oxadiazol-2-yl, 1,3,4-triazol-2-yl, 2-pyridyl, 2-quinolyl, 3-pyridazinyl, 2-pyrimidyl, 1,3,5-triazin-2-yl or 2-pyrazinyl, each of which may be substituted by C₁-C₆-alkyl, C₁-C₆-alkoxy, fluorine, chlorine, bromine, iodine, cyano, —C(═NH)—O—C₁-C₆-alkyl, nitro, C₁-C₆-alkoxycarbonyl, C₁-C₆-alkyl-thio, C₁-C₆-acylamino, formyl, C₂-C₆-alkanoyl, C₆-C₁₀-aryl, C₆-C₁₀-aryloxy, C₆-C₁₀-arylcarbonylamino, mono-C₁-C₆-alkylamino or di-C₁-C₆-alkylamino, N-C₁-C₆-alkyl-N-C₆-C₁₀-arylamino, pyrrolidino, morpholino, piperazino or -piperidino,
where
X¹ is O, S, N—R¹ or CH,
the ring B of the formula 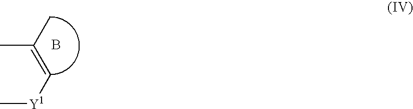
is a radical of one of the formulae 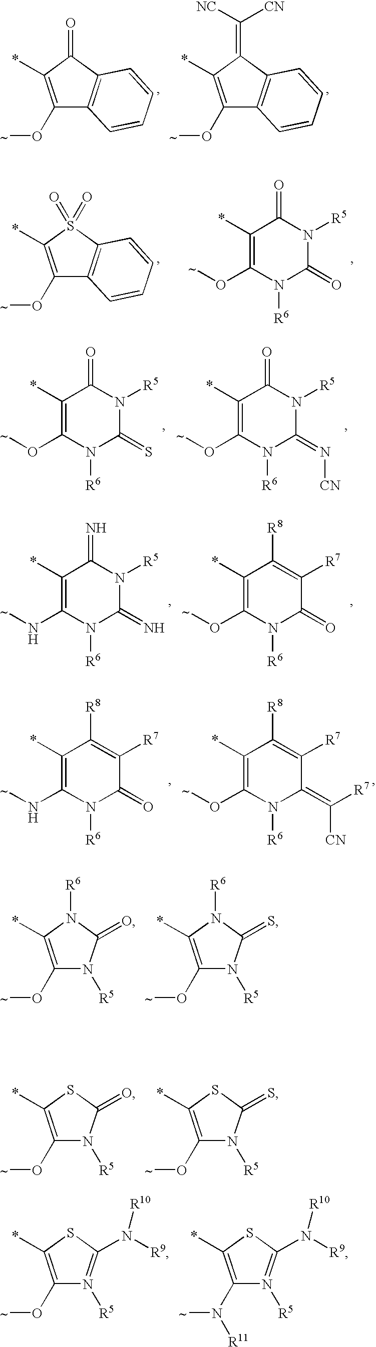 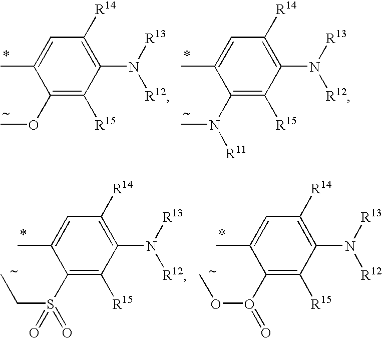
R¹ is hydrogen, methyl, ethyl, propyl, butyl, benzyl or phenethyl,
R⁵ and R⁶ are each, independently of one another, hydrogen, methyl, ethyl, propyl, butyl, benzyl, phenethyl, cyclopentyl, cyclohexyl, phenyl, tolyl, methoxyphenyl or chlorophenyl,
R⁷ is cyano, methoxycarbonyl, ethoxycarbonyl or a radical of the formula 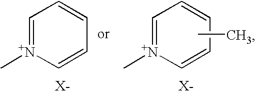
R⁸ is hydrogen, methyl, ethyl, trifluoromethyl, cyano, methoxycarbonyl or ethoxycarbonyl,
R⁹, R¹⁰, R¹² and R¹³ are each, independently of one another, hydrogen, methyl, ethyl, propyl, butyl, cyanoethyl, hydroxyethyl, methoxyethyl, chloroethyl, benzyl, phenethyl, cyclopentyl, cyclohexyl, phenyl, tolyl, methoxyphenyl or chlorophenyl or
NR⁹R¹⁰ and NR¹²R¹³ are each, independently of one another, pyrrolidino, piperidino, piperazino or morpholino,
R¹⁴ and R¹⁵ are each, independently of one another, hydrogen, methyl, ethyl, methoxy or chlorine or
R¹²; R¹⁵ and R¹³; R¹⁴ may in each case form, independently of one another, a —(CH₂)₂—, —(CH₂)₃— or —(CH₂)₂—O— bridge which may be substituted by up to three methyl groups,
R¹¹ is hydrogen, methyl, ethyl, 2,2,3,3-tetrafluoropropyl, formyl, acetyl, trifluoroacetyl, propionyl, butanoyl, benzoyl, pyridoyl, methanesulphonyl, trifluoromethanesulphonyl, ethanesulphonyl, 2,2-difluoroethanesulphonyl, 2,2,2-trifluoroethanesulphonyl, perfluorobutanesulphonyl, benzenesulphonyl, chlorobenzenesulphonyl or toluenesulphonyl,
An⁻ is an anion,
Z is fluorine, chlorine, bromine, CN, acetate, benzoate, methoxy, methylthio or benzenesulphinate;
M is B, Al, Ga, Co, Cr, Fe, Y, La or Ce,
the asterisked (*) bond leads to the azo group and
the bond denoted by “˜” leads to the metal M.

8. Metal complexes according to at least one of claims 1 to 7, characterized in that
the ring A of the formula (III) 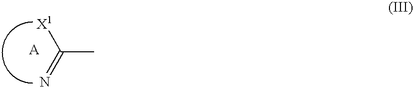
is benzothiazol-2-yl, chlorobenzothiazol-2-yl, methylbenzothiazol-2-yl, methoxybenzothiazol-2-yl or nitrobenzothiazol-2-yl, benzimidazol-2-yl, thiazol-2-yl, phenylthiazol-2-yl, cyanothiazol-2-yl, nitrothiazol-2-yl, 5-fluoro-4-trifluoromethylthiazol-2-yl, 5-phenyl-4-trifluoromethyl-4,5-diphenylimidazol-2-yl, 4,5-dicyanoimidazol-2-yl, 4,5-bismethoxy-carbonylimidazol-2-yl or 4,5-bisethoxycarbonylimidazol-2-yl, pyrazol-5-yl, 1,3,4-thiadiazol-2-yl, 5-phenoxy-1,3,4-thiadiazol-2-yl, 5-methylthio-1 ,3,4-thiadiazol-2-yl, 5-dimethylamino- 1,3,4-thiadiazol-2-yl, 5-diethylamino-1,3,4-thiadiazol-2-yl, 5-di(iso)propylamino-1,3,4-thiadiazol-2-yl, 5-N-methyl-N-cyanoethylamino-1,3,4-thiadiazol-2-yl, 5-pyrrolidino-1,3,4-thiadiazol-2-yl, 5-phenyl-1,3,4-thiadiazol-2-yl, 5-methyl-1,3,4-thiadiazol-2-yl, 1,2,4-thiadiazol-5-yl, 3-methylthio-1,2,4-thiadiazol-5-yl, 3-methanesulphonyl-1,2,4-thiadiazol-5-yl, 3-phenyl-1,2,4-thiadiazol-5-yl, 5-methyl-1,2,4-thiadiazol-3-yl, 1,3,4-triazol-2-yl, 2-pyridyl, 2-quinolyl, 2-pyrimidyl, 4-cyano-2-pyrimidyl, 4,6-dicyano-2-pyrimidyl, 1,3,5-triazin-2-yl or 2-pyrazinyl,
where
X¹ is O, S, N—R′ or CH,
R¹ is hydrogen, methyl, ethyl or benzyl,
the ring B of the formula (IV) 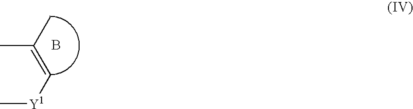
is a radical of one of the formulae 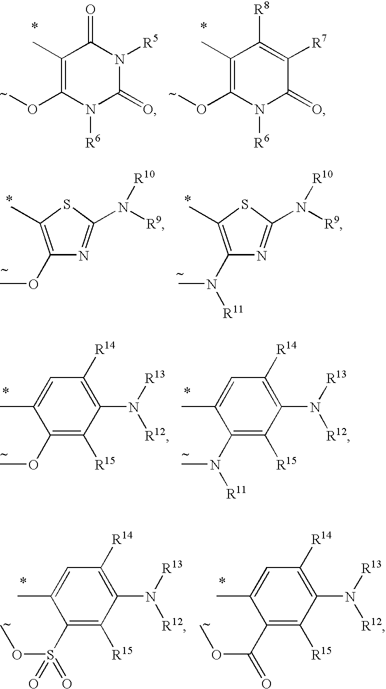
R⁵ and R⁶ are each, independently of one another, hydrogen, methyl or ethyl,
R⁷ is cyano or methoxycarbonyl,
R⁸ is hydrogen, methyl, trifluoromethyl or cyano,
R⁹, R¹⁰, R¹² and R¹³ are each, independently of one another, hydrogen, methyl, ethyl, propyl, butyl, cyanoethyl, methoxyethyl, chloroethyl, benzyl, cyclohexyl, phenyl, tolyl or methoxyphenyl or
NR⁹R¹⁰ and NR¹²R¹³ are each, independently of one another, pyrrolidino, piperidino or morpholino,
R¹⁴ and R¹⁵ are each, independently of one another, hydrogen, methyl or methoxy or
R¹²; R¹⁵ and R¹³; R¹⁴ may in each case form, independently of one another, a —(CH₂)₂— or —(CH₂)₃— bridge,
R¹¹ is 2,2,3,3-tetrafluoropropyl, acetyl, propionyl, benzoyl, pyridoyl, methanesulphonyl, trifluoromethanesulphonyl, ethanesulphonyl, perfluorobutanesulphonyl or benzenesulphonyl,
An⁻ is tetrafluoroborate, perchlorate, hexafluorophosphate, iodide, nitrate, methoxyacetate, methanesulphonate, ethanesulphonate, trifluoro-methanesulphonate, benzenesulphonate, toluenesulphonate, butylbenzenesulphonate, chlorobenzenesulphonate, dodecylbenzene-sulphonate, naphthalenesulphonate, an equivalent of polystyrene-sulphonate or the anion of the formula 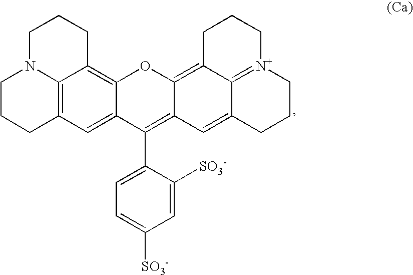
Z is fluorine,
M is B, Al or Co,
the asterisked (*) bond leads to the azo group and
the bond denoted by “˜” leads to the metal M.

9. Metal complexes according to at least one of claims 1 to 7, characterized in that
the ring A of the formula (III) 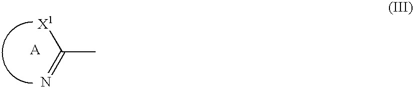
is 4,5-dicyanoiraidazol-2-yl, 1-methyl4,5-dicyanoimidazol-2-yl, 1-ethyl-4,5-dicyanoimidazol-2-yl, 1-benzyl4,5-dicyanoimidazol-2-yl, 1-(2,2,2-trifluoroethyl)4,5-dicyanoimidazol-2-yl, 3-phenyl-1,2,4-thiadiazolyl, 3-methanesulphonyl-1,2,4-thiadiazolyl, 5-dimethylamnino- 1 ,3,4-thiadiazolyl, 5-diisopropylamino-1,3,4-thiadiazolyl, 5-pyrrolidino-1,3,4-thiadiazolyl, 5-phenyl-1,3,4-thiadiazol-2-yl, 5-methyl-1,3,4-thiadiazolyl, 2-pyridyl, 2-pyrimidyl, 4-cyano-2-pyrimidyl,
the ring B of the formula (IV) 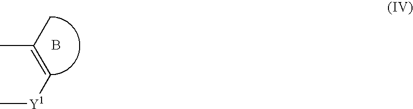
is a radical of the formula 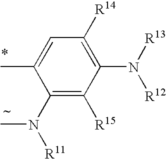
R¹² and R¹³ are each, independently of one another, hydrogen, methyl, ethyl, propyl, cyanoethyl, benzyl, cyclohexyl or phenyl or
NR¹²R¹³ is pyrrolidino, piperidino or morpholino,
R¹⁴ and R¹⁵ are each hydrogen or
R¹²; R¹⁵ and R¹³; R¹⁴ in each case form, independently of one another, a —(CH₂)₂— or —(CH₂)₃— bridge,
R¹¹ is methanesulphonyl, trifluoromethanesulphonyl or perfluorobutanesulphonyl,
An⁻ is tetrafluoroborate, perchlorate, hexafluorophosphate, iodide, nitrate, trifluoromethanesulphonate or the anion of the formula 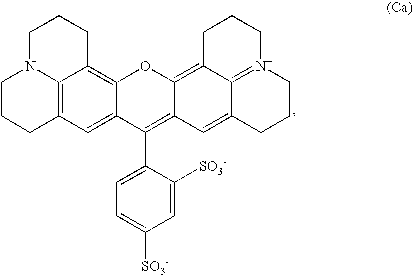
M is Co,
the asterisked (*) bond leads to the azo group and
the bond denoted by “˜” leads to the metal M.

10. A process for preparing metal complexes according to claim 1, characterized in that a metal salt is reacted with an azo compound of the formula (Ic) 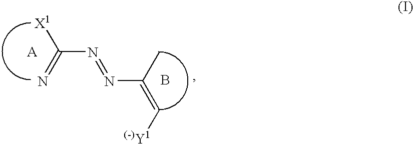
where
X¹ is O, S, N—R¹ or CH,
A together with X¹ and N forms a five- or six-membered aromatic or pseudoaromatic heterocyclic ring which contains from 1 to 4 heteroatoms and/or may be benzo- or naphtho-fused and/or substituted by nonionic radicals,
Y¹ is O, S, N—R², COO, SO₃, N—CO—R³ or N—SO₂—R³,
B is a five- or six-membered carbocyclic or heterocyclic ring which can contain from 1 to 4 heteroatoms and/or may be benzo- or naphtho-fused and/or substituted by nonionic radicals,
R¹ and R² are each, independently of one another, hydrogen, C₁-C₆-alkyl, C₆-C₁₀-aryl or C₇-C₁₂-aralkyl,
R³ is C₆-C₁₂-alkyl, C₃-C₇-cycloalkyl, C₂-C₆-alkenyl, C₇-C₁₂-aralkyl, C₆-C₁₀-aryl, C₁-C₆-alkoxy or mono-C₁-C₆-alkylamino or bis-C₁-C₆-alkylamino.

11. Use of metal complexes according to claim 1 as light-absorbent compounds in the information layer of write-once optical data carriers.

12. Use according to claim 11, characterized in that the optical data carrier can be written on and read by means of blue laser light, in particular light having a wavelength in the range 360-460 nm.

13. Use according to claim 11, characterized in that the optical data carrier can be written on and read by means of red laser light, in particular light having a wavelength in the range 600-700 nm.

14. Use of metal complexes of azo ligands as light-absorbent compounds in the information layer of write-once optical data carriers which can be written on and read by means of blue laser light, in particular light having a wavelength in the range 360-460 nm.

15. Solution of metal complexes according to claim 1, characterized in that it contains at least 1% by weight of the metal complex and in that the solvent used is 2,2,3,3,-tetrafluoropropanol, propanol, butanol, pentanol, hexanol, diacetone alcohol, dibutyl ether, heptanone or a mixture thereof.

16. Solution of metal complexes according to claim 15, characterized in that the solvent used is propanol, butanol, pentanol, hexanol, diacetone alcohol or a mixture thereof.

17. Solution of metal complexes according to claim 15, characterized in that the solvent used is a mixture of propanol/diacetone alcohol or butanol.

18. Optical data carrier comprising a preferably transparent substrate which may, if desired, have previously been coated with one or more reflection layers and on whose surface a light-writeable information layer, if desired one or more reflection layers and if desired a protective layer or a further substrate or a covering layer have been applied, which can be written on and read by means of blue or red light, preferably laser light, where the information layer comprises a light-absorbent compound and, if desired, a binder, characterized in that at least one metal complex according to at least one of claims 1 to 9 is used as light-absorbent compound.

19. Optical data carrier according to claim 18, characterized in that the light-absorbent compound has the formula (Ia)
[(I)]₂⁻ M³⁺ An− (Ia)
where the two ligands of the formula (I) are each, independently of one another, as defined above,
M is a metal and
An⁻ is an anion,
or has the formula (Ib)
[(I)]₂⁻ M²⁺−Z (Ib)
where the two ligands of the formula (I) are, independently of one another, as defined above,
M is a metal,
Z is halogen, CN, R⁴—O—, R⁴—S—, R⁴—SO₂—, R⁴—CO—O—, R⁴—SO₂—O—, R⁴—CO—NH— or R⁴—SO₂—NH— and
R⁴ is C₁-C₆-alkyl, C₃-C₇-cycloalkyl, C₇-C₁₂-aralkyl or C₆-C₁₀-aryl.

20. Optical data carrier according to claim 19, characterized in that the metal M in the formula (Ia) or (Ib) is a trivalent metal, transition metal or rare earth, in particular B, Al, Ga, In, V, Co, Cr, Fe, Y, La, Ce, Pr, Nd, Sm, Eu, Gd, Th.

21. Optical data carrier according to one or more of claims 18 to 20, characterized in that a metal complex containing an azo ligand of the formula (I) 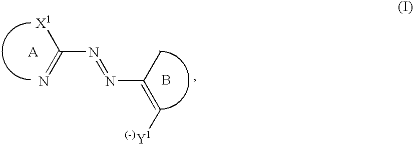
where
X¹ is O, S, N—R¹ or CH,
A together with X¹ and N forms a five- or six-membered aromatic or pseudoaromatic heterocyclic ring which contains from 1 to 4 heteroatoms and/or may be benzo- or naphtho-fused and/or substituted by nonionic radicals,
Y¹ is O, S, N—R², COO, SO₃, N—CO—R³ or N—SO₂—R³,
B is a five- or six-membered carbocyclic or heterocyclic ring which may contain from 1 to 4 heteroatoms and/or may be benzo- or naphtho-fused and/or substituted by nonionic radicals,
R¹ and R² are each, independently of one another, hydrogen, C₁-C₆-alkyl, C₆-C₁₀-aryl or C₇-C₁₂-aralkyl,
R³ is C₁-C₁₂-alkyl, C₃-C₇-cycloalkyl, C₂-C₆-alkenyl, C₇-C₁₂-aralkyl, C₆-C₁₀-aryl, C₁-C₆-alkoxy or mono-C₁-C₆-alkylamino or bis-C₁-C₆-alkylamino.

22. Process for producing the optical data carriers according to claim 18, which is characterized in that a preferably transparent substrate which may, if desired, have previously been coated with a reflection layer is coated with metal complexes according to claim 1, if desired in combination with suitable binders and additives and, if desired, suitable solvents, and provided, if desired, with a reflection layer, further intermediate layers and, if desired, a protective layer or a further substrate or a covering layer.

23. Optical data carriers according to claim 18 which have been written on by means of blue or red light, in particular red light, in particular red laser light.
